(19) United States
(12) Patent Application Publication
(10) Pub. No.: US 2011/0107256 A1
(43) Pub. Date: May 5, 2011

(54) Zooming Task Management

(75) Inventors: George G. Robertson, Seattle, WA (US); Daniel Chaim Robbins, Seattle, WA (US)

(73) Assignee: Microsoft Corporation, Redmond, WA (US)

(21) Appl. No.: 12/941,454

(22) Filed: Nov. 8, 2010

Related U.S. Application Data
(62) Division of application No. 11/643,088, filed on Dec. 21, 2006, now abandoned.

(51) Int. Cl. G06F 3/048

(52) U.S. Cl. 715/800

(57) ABSTRACT

A user interface is provided that includes a focused view of a task and a user interface object for a second task. If the object is selected, the user interface is fluidly zoomed into the object and then out from the object to focus on the second task. A user interface is also provided that includes a display area having a focus area and a periphery. If a task represented in the periphery is selected, the display area fluidly zooms into the task. The display area may be fluidly zoomed out of the task to show the focus area and periphery. A user interface is also provided that includes a 3D gallery with tasks represented in the gallery. If one of the tasks is selected, the user interface fluidly zooms into focus on the selected task. The user interface may fluidly zooms out of a task to reveal the gallery.

### CROSS-REFERENCE TO RELATED APPLICATIONS

This application is a divisional of U.S. patent application Ser. No. 11/643,088 filed on Dec. 21, 2006, and entitled “Zooming Task Management,” which is expressly incorporated herein by reference in its entirety.

### BACKGROUND

Graphical computer user interfaces (“GUIs”) display data produced by an operating system and application programs within different windows on a display screen. For example, a user may simultaneously have one window open for browsing files stored on a mass storage device, another window open for editing a word processing document, and another window open for browsing the World Wide Web. Modern GUIs allow a virtually unlimited number of windows to be opened in this manner.

It has been shown that computer users open different GUI windows for different activities. Users also size and locate the GUI windows differently for different activities. For example, when a user performs the activity of writing a computer program, they may have two windows open in a split screen format, with one window containing a program editor and another window containing the output of the program being created. When the user is performing a different activity, however, they may utilize an entirely different arrangement of windows. For instance, if the user is sending and reading electronic mail messages, they may have an electronic mail application program open so that it occupies most of the display screen and a scheduling application program open in a small part of the display screen.

Since each activity performed by a user may be associated with different windows arranged in different layouts, GUIs have been created that allow a user to create arrangements of windows associated with a particular activity, and to switch between the arrangements. For instance, utilizing such a GUI, a user may create an arrangement of windows suitable for word processing and another completely separate arrangement of windows suitable for browsing the World Wide Web. Different mechanisms may also be provided by such GUIs that permit a user to switch between the different arrangements of windows. For instance, in one such GUI, an overview showing all of the arrangements of windows may be displayed. The user can then switch to one of the arrangements by making a selection from the overview.

Although these GUIs generally increase productivity by allowing a user to create arrangements of windows and to switch between them, these previous GUIs also suffer from several drawbacks. First, in previous GUIs the context switch between arrangements of windows or between an arrangement of windows and an overview has typically been abrupt. In other GUIs, the transition between arrangements of windows was complex or required the movement of a significant number of windows. In each of these cases, the context switch may be disruptive to the overall user experience and, consequently, to user productivity.

It is with respect to these considerations and others that the disclosure made herein is provided.

### SUMMARY

Methods and computer-readable media are provided herein for visually managing tasks within a GUI. A task is a collection of user interface windows associated with a particular activity. Through the embodiments presented herein, a user may easily and fluidly switch between tasks and between tasks and an overview of the tasks within a GUI.

According to one embodiment, a user interface is provided in which a focused view of a task is shown in a display area. In the focused view, the windows of the task may be utilized and manipulated by a user. A selectable user interface object corresponding to a second task is also shown within the display area. For instance, the user interface object may be represented as a door, thereby indicating that the user interface object provides a doorway into another task. If the user interface object is selected, the display area is fluidly zoomed into the user interface object and then out of the user interface object to reveal a focused view of the second task within the display area. A fluid transition may be made between any number of tasks in a similar manner.

A user interface object corresponding to an overview of the tasks may also be shown within the display area. When the user interface object corresponding to the overview is selected, the display area is fluidly zoomed into the user interface object and then out of the user interface object to thereby reveal the overview of the tasks in the display area. Alternatively, when the user interface object corresponding to the overview is selected, the display area may be zoomed back from the focused view of the task to the overview. The overview includes a visual representation of each of the tasks. If one of the tasks is selected in the overview, the display area is fluidly zoomed into the selected task to reveal a focused view of the selected task.

According to another embodiment, a user interface is provided that includes a display area having a focus area and a periphery defined therein. The focus area is a subset of the display area and is surrounded by the periphery. A user interface object, such as a window, may be displayed within the focus area. If the user interface object is moved from the focus area to the periphery, the size of the user interface object is progressively reduced as the user interface object is moved from the focus area to the periphery. In this manner, a scaled down representation of a task may be displayed in the periphery. If the user interface object is moved from the periphery back to the focus area, the size of the user interface object is progressively increased as the user interface object is moved from the periphery to the focus area. The user interface object is displayed at its original size when it reaches its final location within the focus area.

In this embodiment, the scaled down representation of a task displayed in the periphery may be selected in order to bring the corresponding task into focus. If a request to focus on a task represented in the periphery is received, the display area is fluidly zoomed into the task to thereby display a focused view of the task in the display area. If a request is received to remove focus from the task, the display area is fluidly zoomed out of the task to thereby display the focus area and the periphery within the display area. In embodiments, the focus area and periphery may be displayed during the focused view of a task.

According to another embodiment, a user interface is provided that includes the display of a three-dimensional representation of an art gallery. The gallery includes visual representations of tasks. The tasks may be displayed within frames on the walls of the gallery, within frames supported by easels located within the gallery, or in another manner. When a request is received to focus on one of the tasks displayed within the gallery, the user interface fluidly zooms into the visual representation of the selected task to thereby display a focused view of the task. Windows within the task may then be manipulated and otherwise utilized within the focused view of the task. When a request is received to remove focus from the selected task, the user interface fluidly zooms out from the visual representation of the task to thereby display the task gallery.

The above-described subject matter may also be implemented as a computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIGS. 1A-1J, 2A-2J, and 3A-3G are screen diagrams showing aspects of one user interface provided herein for graphically managing tasks;

FIG. 4 is a flow diagram showing an illustrative process for providing the user interface shown in FIGS. 1A-1J, 2A-2J, and 3A-3G according to one embodiment presented herein;

FIGS. 5A-5F are screen diagrams showing aspects of another user interface provided herein for graphically managing tasks;

FIG. 6 is a flow diagram showing an illustrative process for providing the user interface shown in FIGS. 5A-5F according to one embodiment presented herein;

FIGS. 7A-7D are screen diagrams showing aspects of yet another user interface provided herein for graphically managing tasks;

FIG. 8 is a flow diagram showing an illustrative process for providing the user interface shown in FIGS. 7A-7D according to one embodiment presented herein; and

FIG. 9 is a computer architecture diagram showing a computer architecture suitable for implementing the various user interfaces described herein.

### DETAILED DESCRIPTION

The following detailed description is directed to systems, methods, and computer-readable media for managing tasks within a graphical user interface. While the subject matter described herein is presented in the general context of program modules that execute in conjunction with the execution of an operating system and application programs on a computer system, those skilled in the art will recognize that other implementations may be performed in combination with other types of program modules.

Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and which are shown by way of illustration specific embodiments or examples. Referring now to the drawings, in which like numerals represent like elements throughout the several figures, aspects of a computing system and methodology for managing tasks within a graphical user interface will be described.

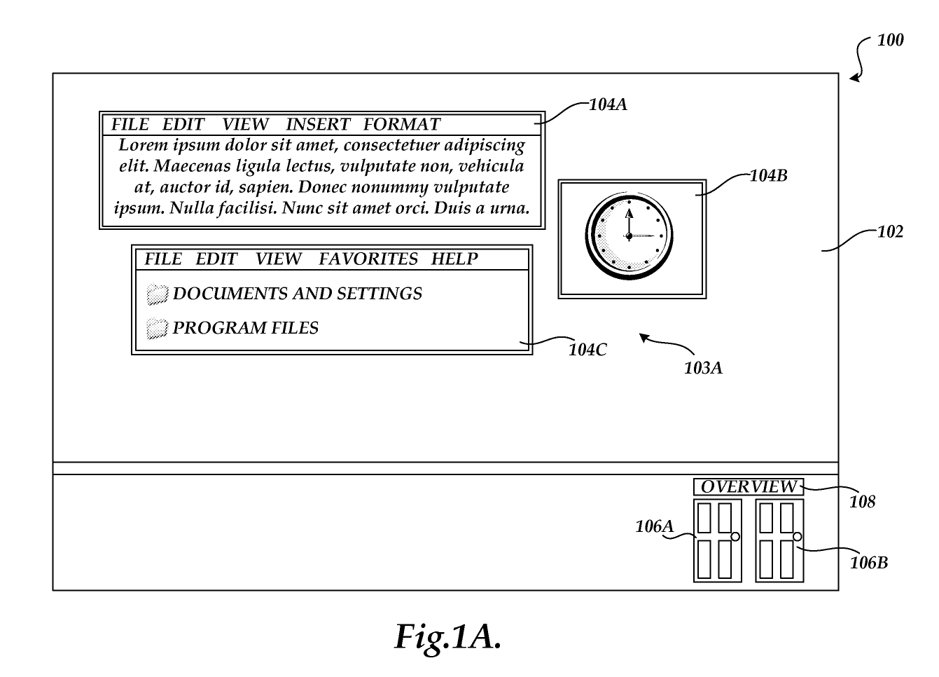

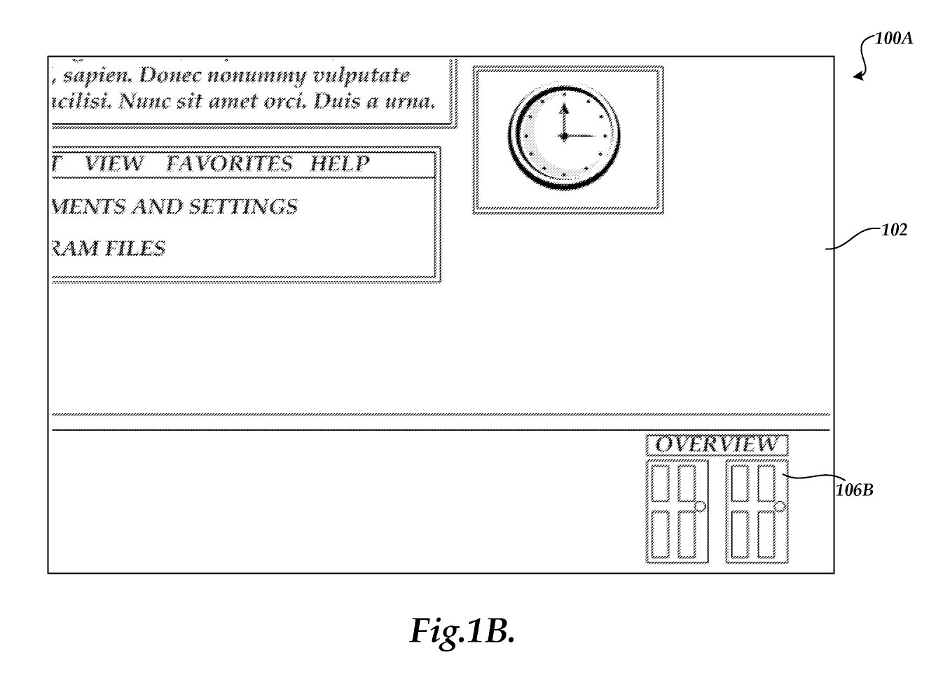

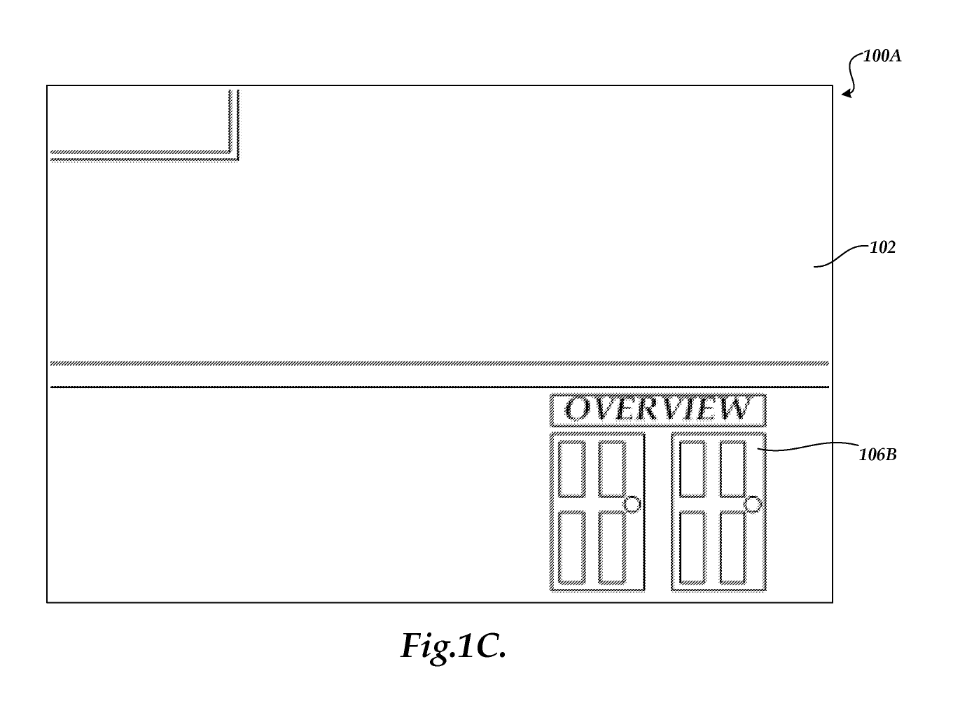

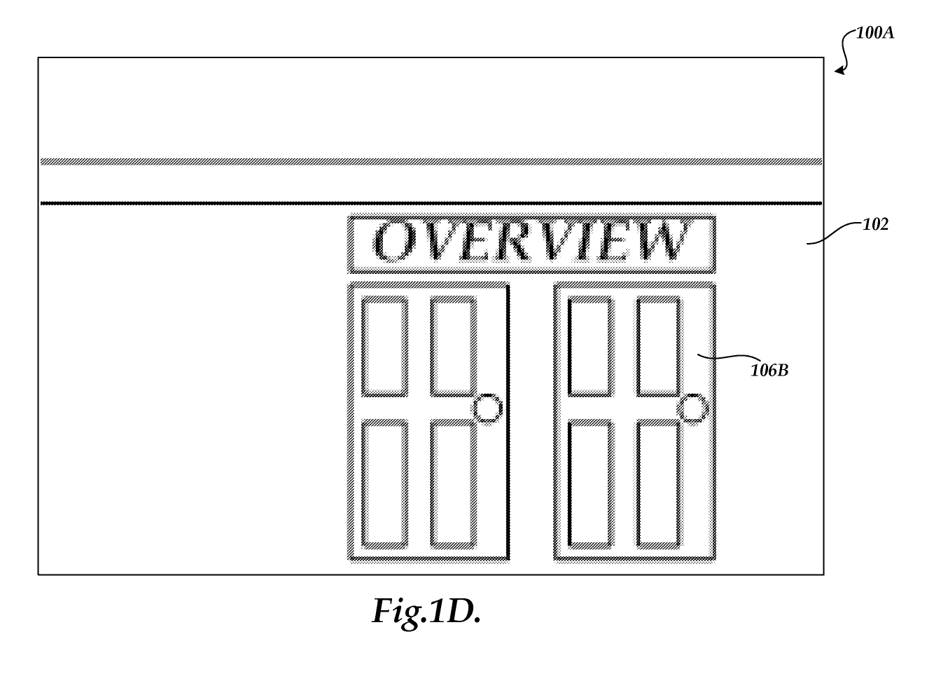

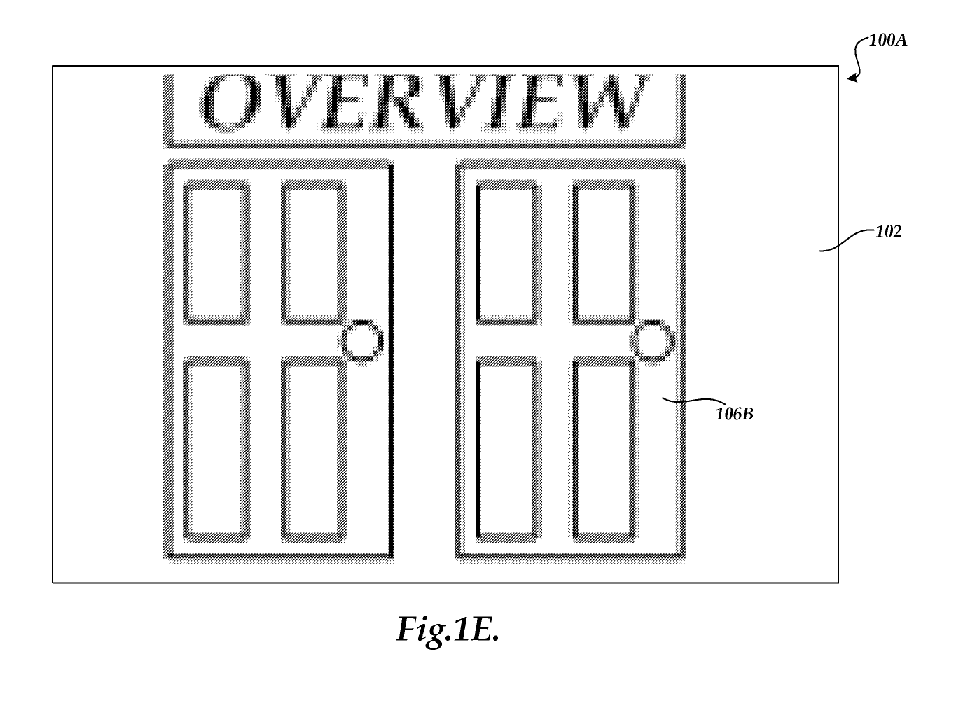

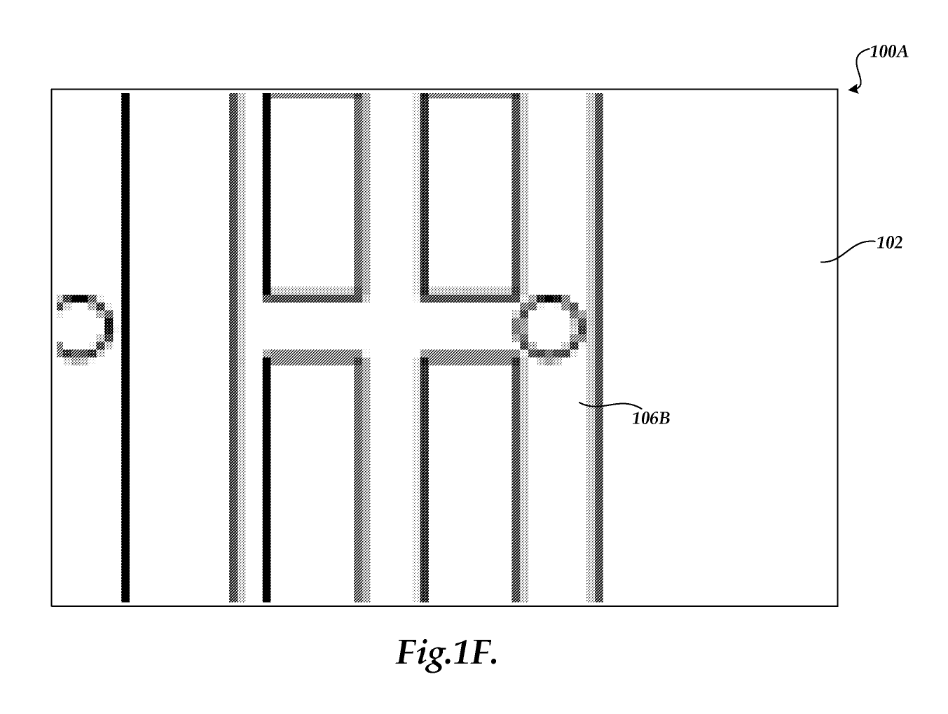

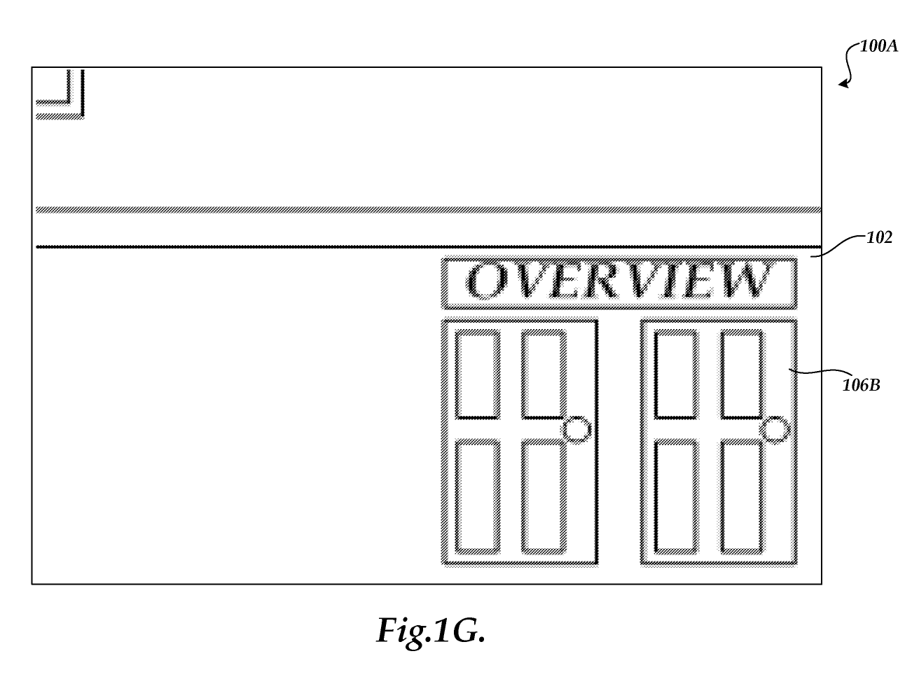

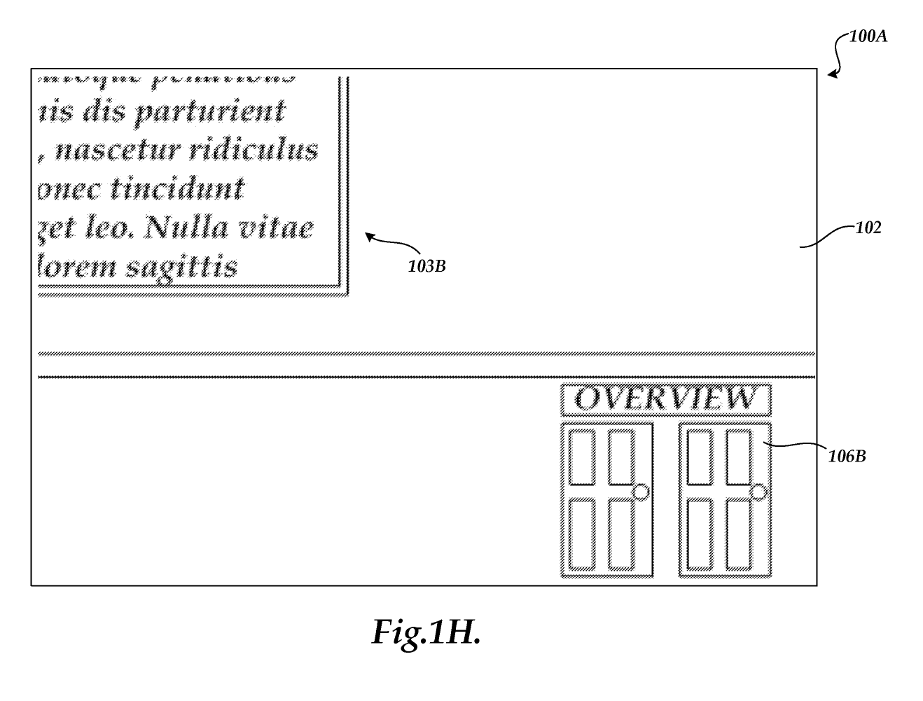

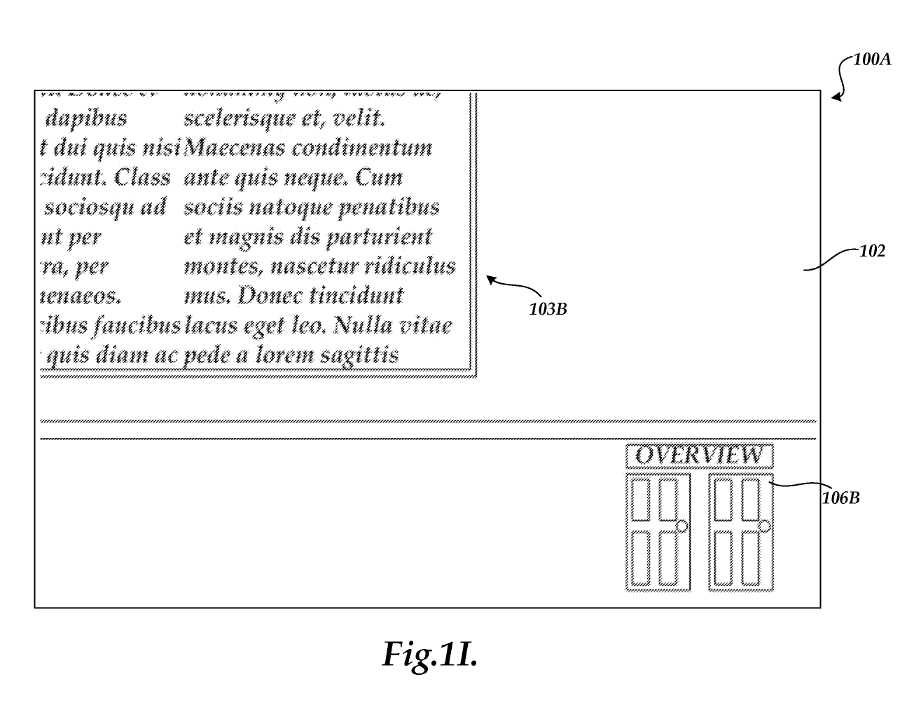

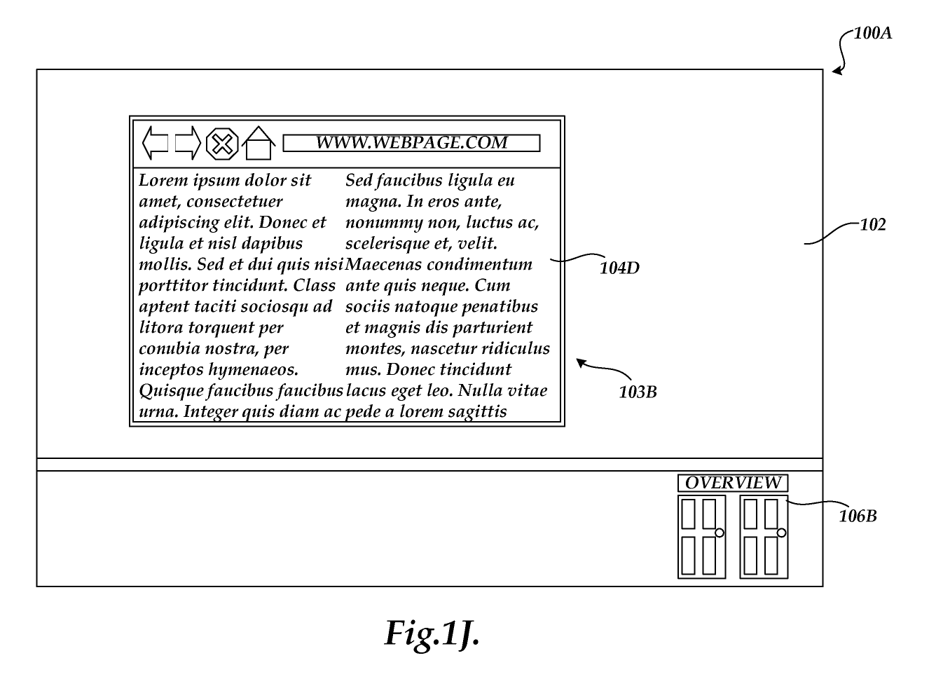

FIGS. 1A-1J are screen diagrams illustrating aspects of one user interface for visually managing tasks provided herein. In the illustrative user interface shown in FIGS. 1A-1J, user interface windows may be displayed that are generated by an operating system or application programs. For instance, the illustrative user interface 100 shown in FIG. 1A includes a display area 102 in which the user interface windows 104A-104C are being displayed. In this example, a text editing application program provides the user interface window 104A, an operating system provides the user interface windows 104B for browsing files, and a clock application program provides the user interface window 104B showing the current time. It should be appreciated that the windows shown in the FIGURES are illustrative and that virtually any number and type of user interface windows may be displayed within the user interface 100.

User interface windows may be opened, organized, and sized within the user interface 100 based upon the particular activity being performed. As utilized herein, the term “task” is utilized to refer to a collection of user interface windows associated with a particular activity. For instance, as shown in FIG. 1A, a task 103A has been created that consists of the user interface windows 104A, 104B, and 104C, sized and arranged in the manner shown within the display area 102. Utilizing the embodiments provided herein, a user may create any number of tasks and switch between them. The task that is displayed within the display area 102 is the task that is in focus. Additional details regarding various aspects provided herein for switching the focus between tasks are provided below.

As shown in FIG. 1A, the display area 102 may further include user interface objects 106A-106B, each of which corresponds to a task. The user interface object 106A corresponds to the task 103A shown in FIG. 1A. The user interface object 106B corresponds to a task 103B which is shown in FIG. 1J and described below. In one implementation, the user interface objects 106A-106B are represented as doors. It should be appreciated that any number of user interface objects 106A-106B may be displayed corresponding to an equal number of tasks 103. Use of the user interface objects 106A-106B to switch between tasks will be described in greater detail below.

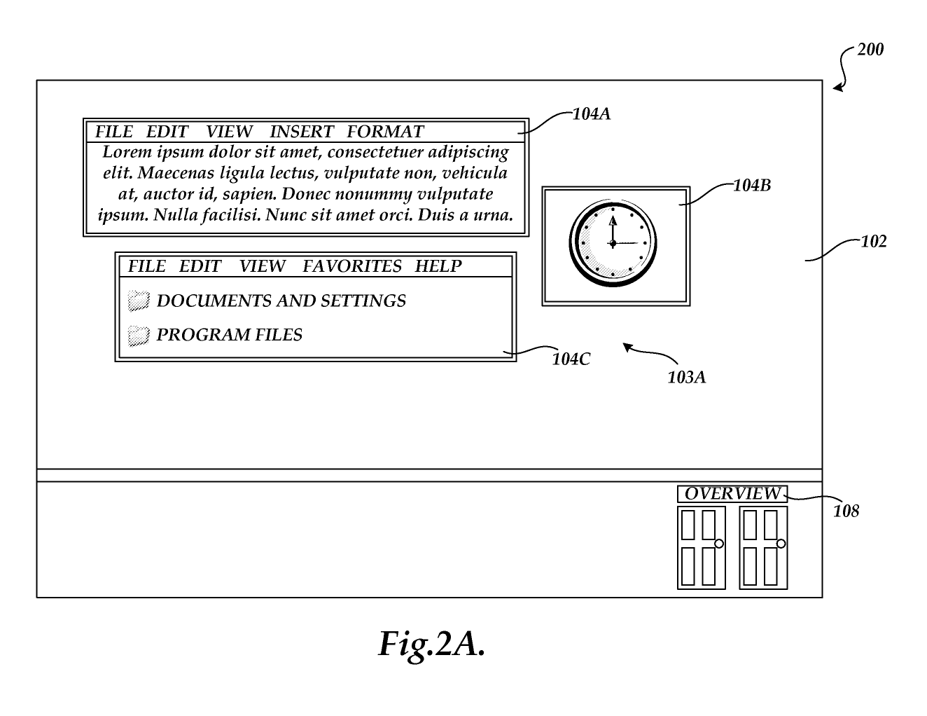

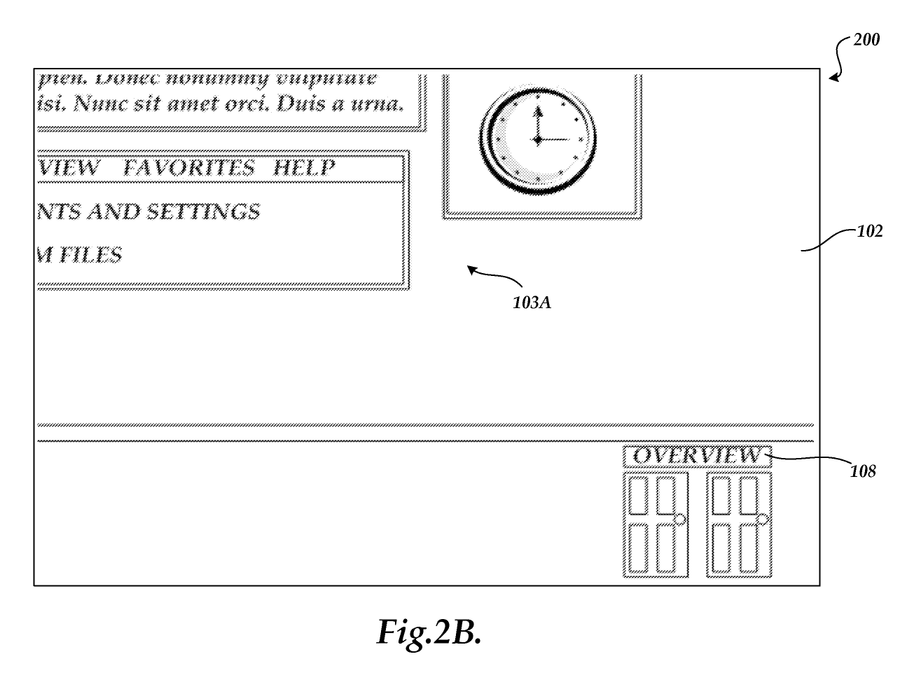

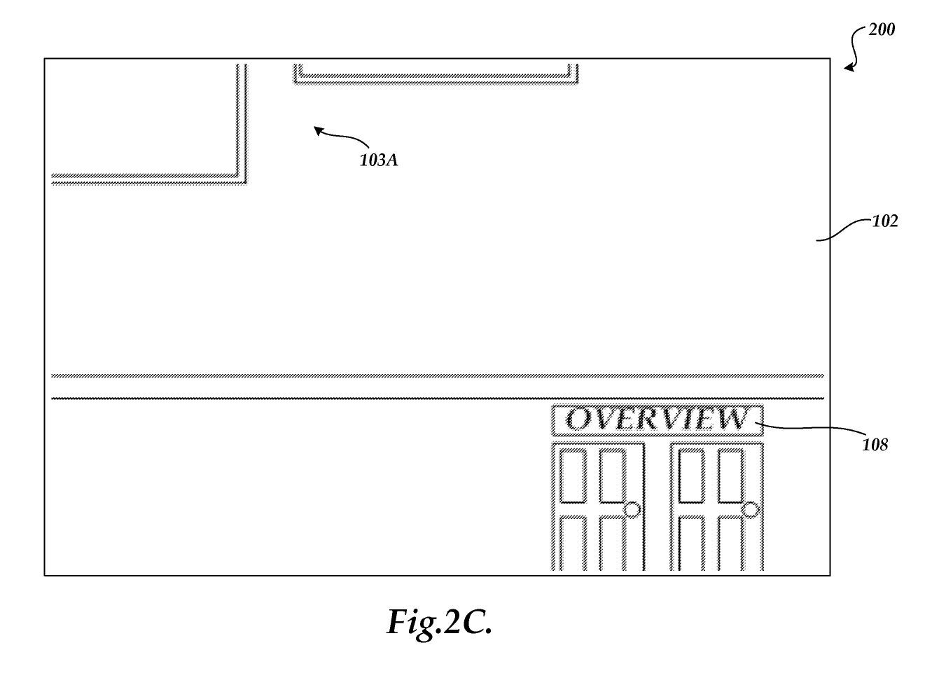

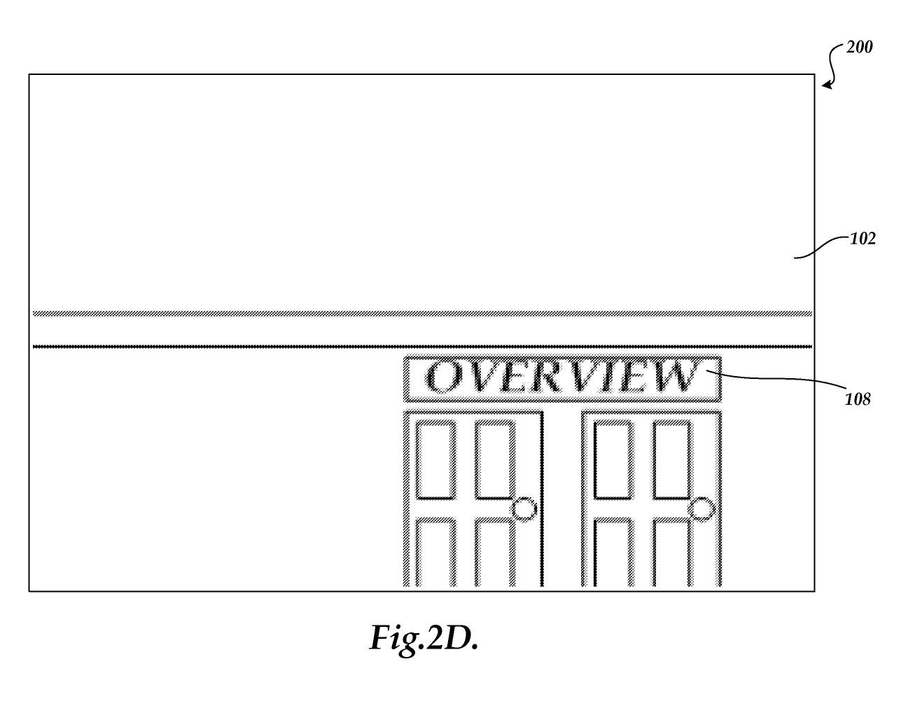

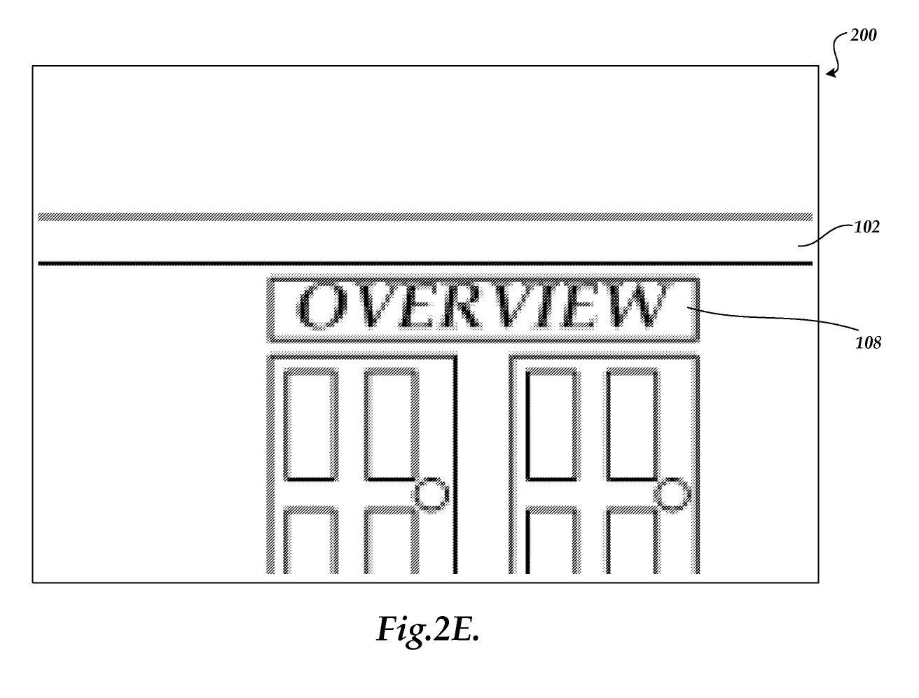

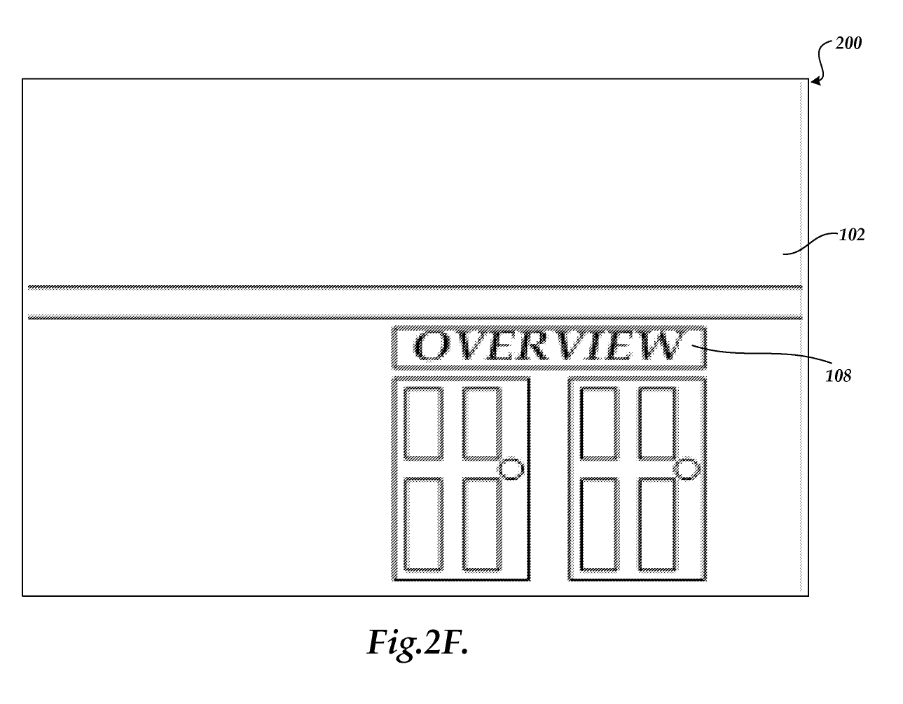

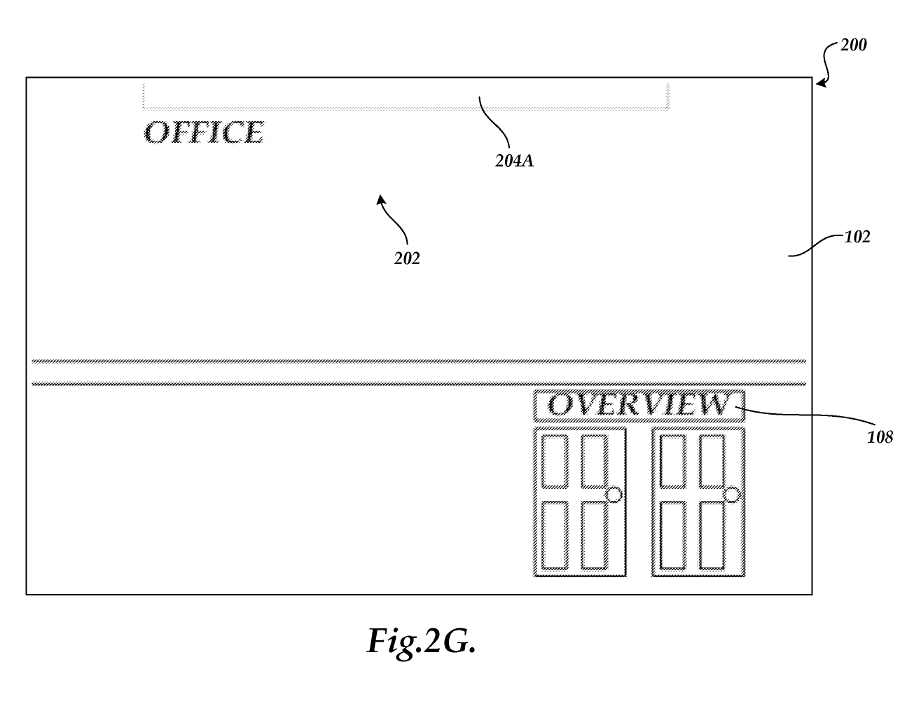

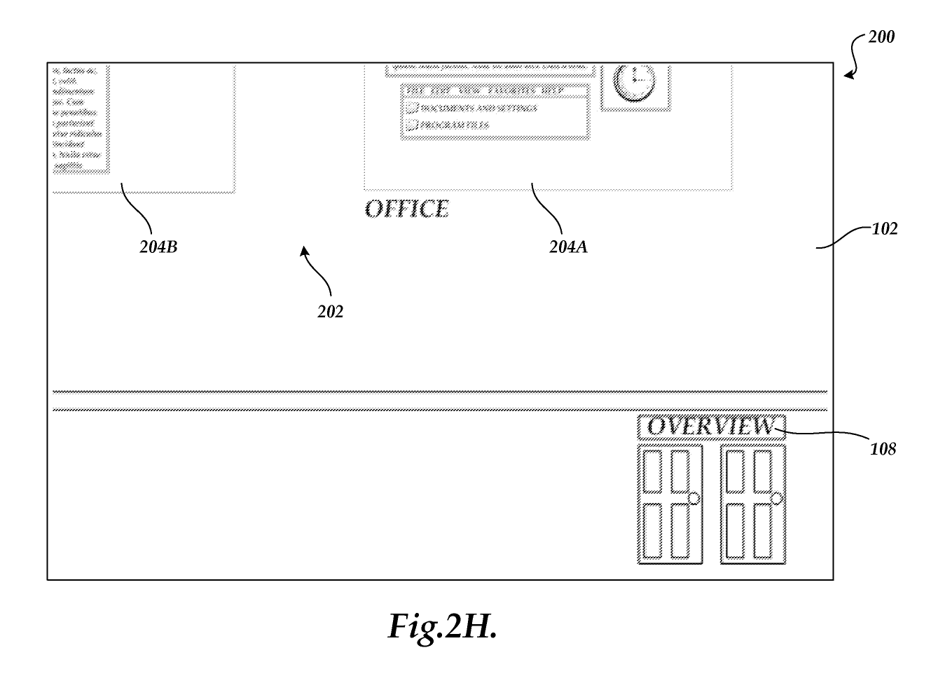

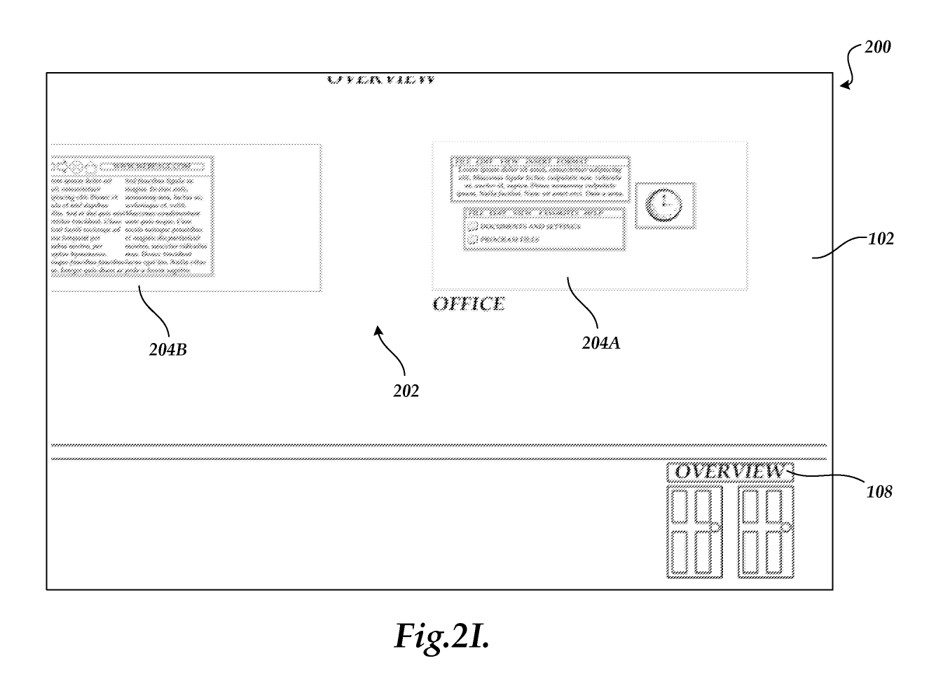

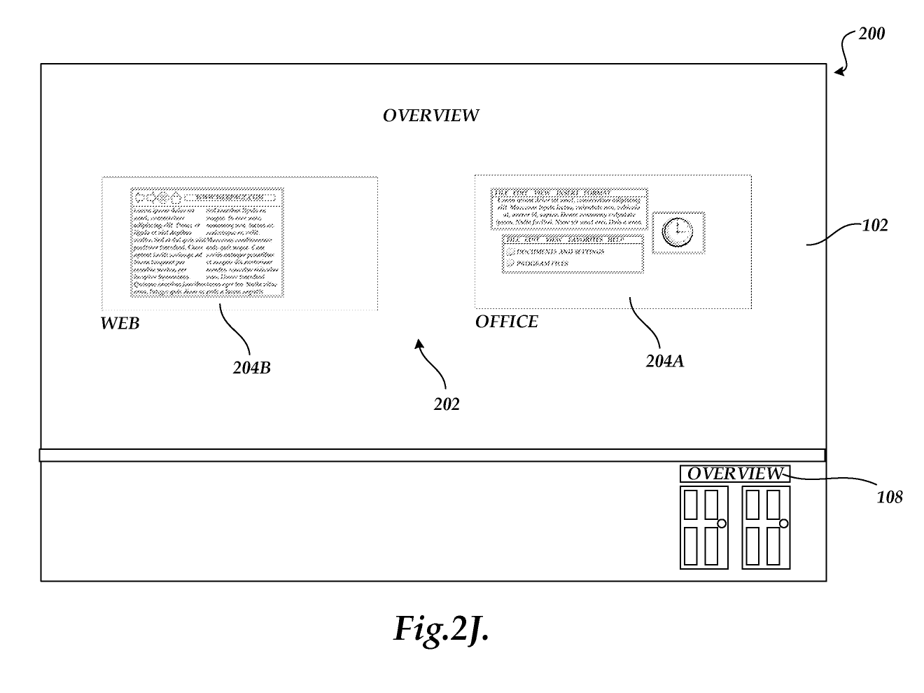

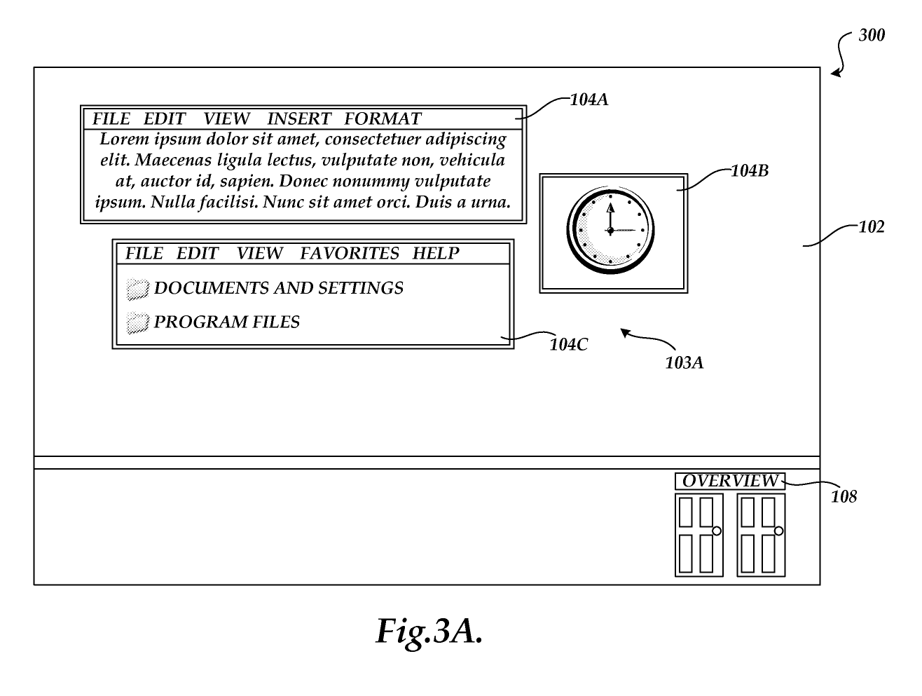

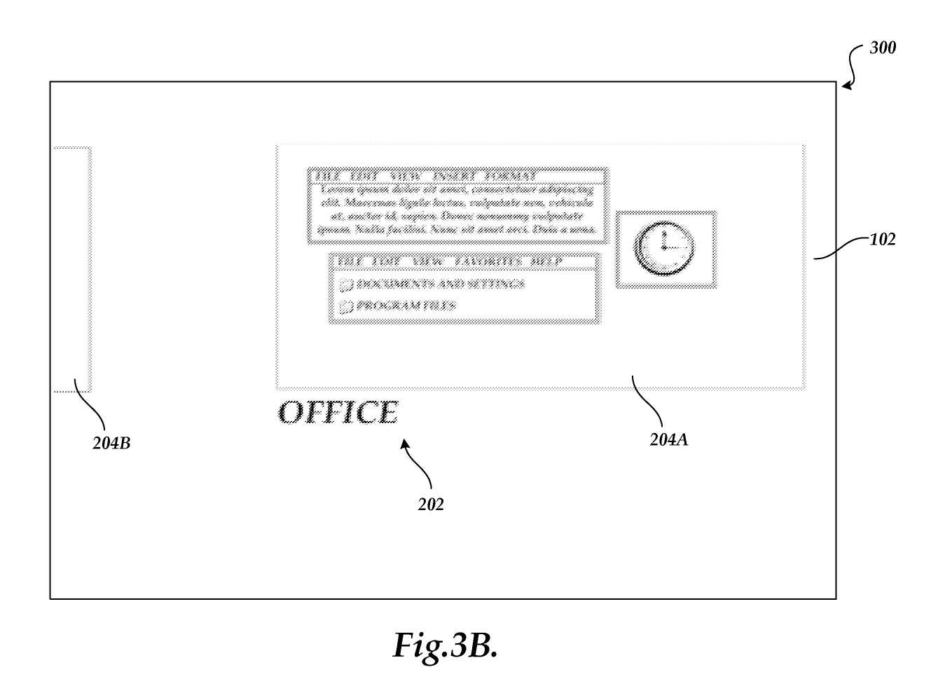

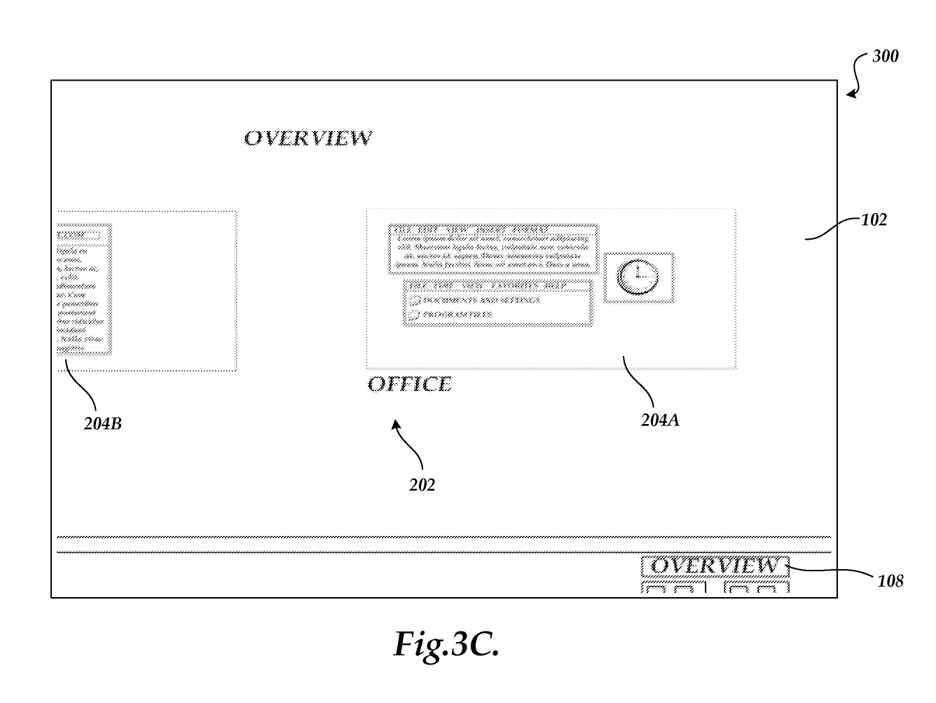

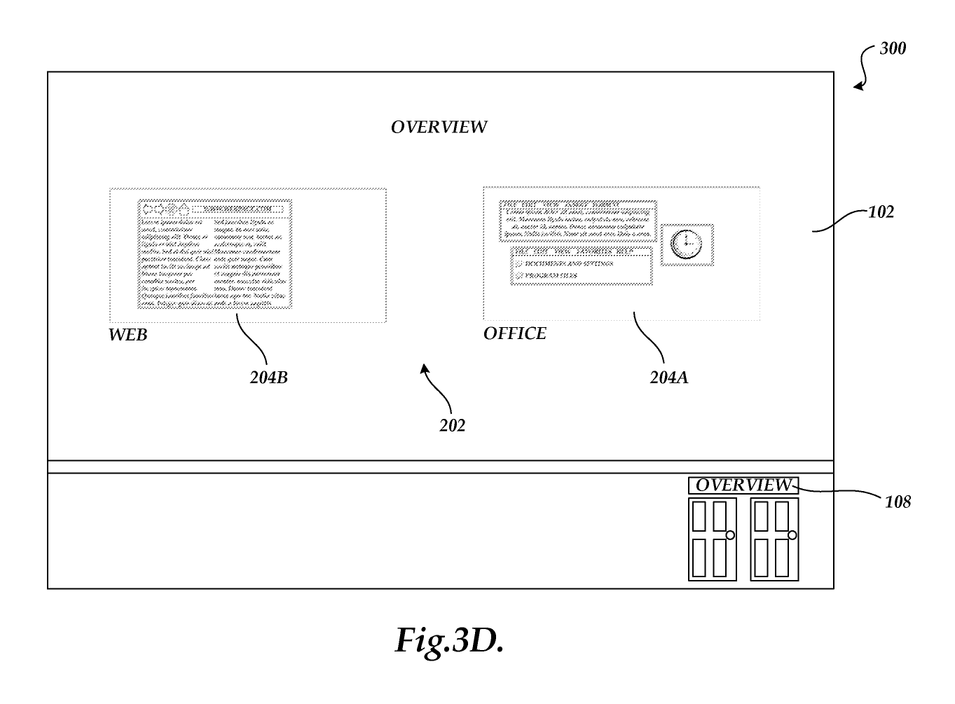

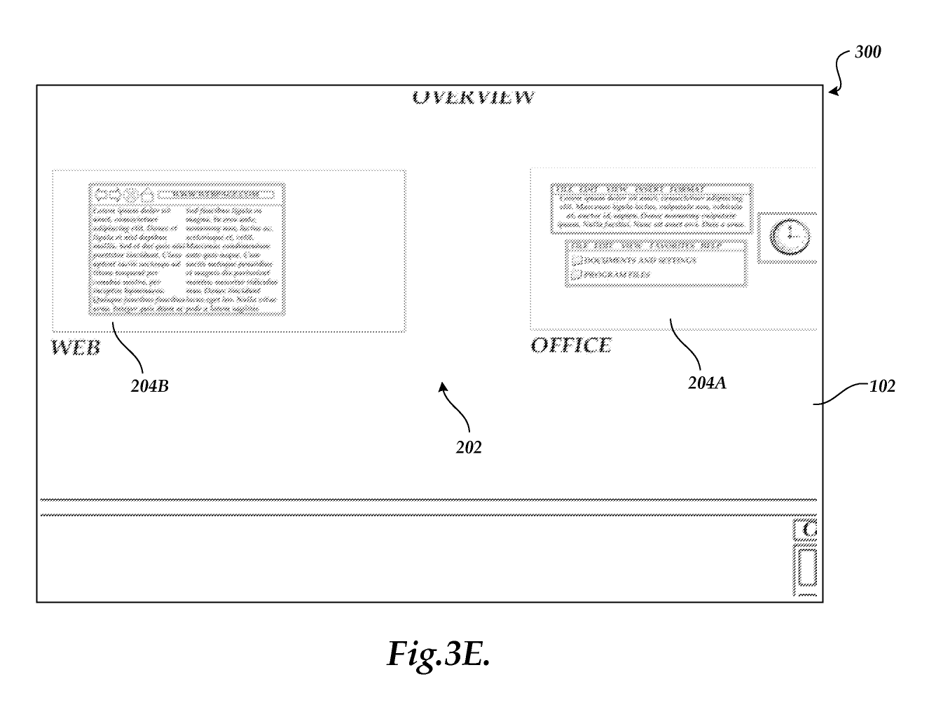

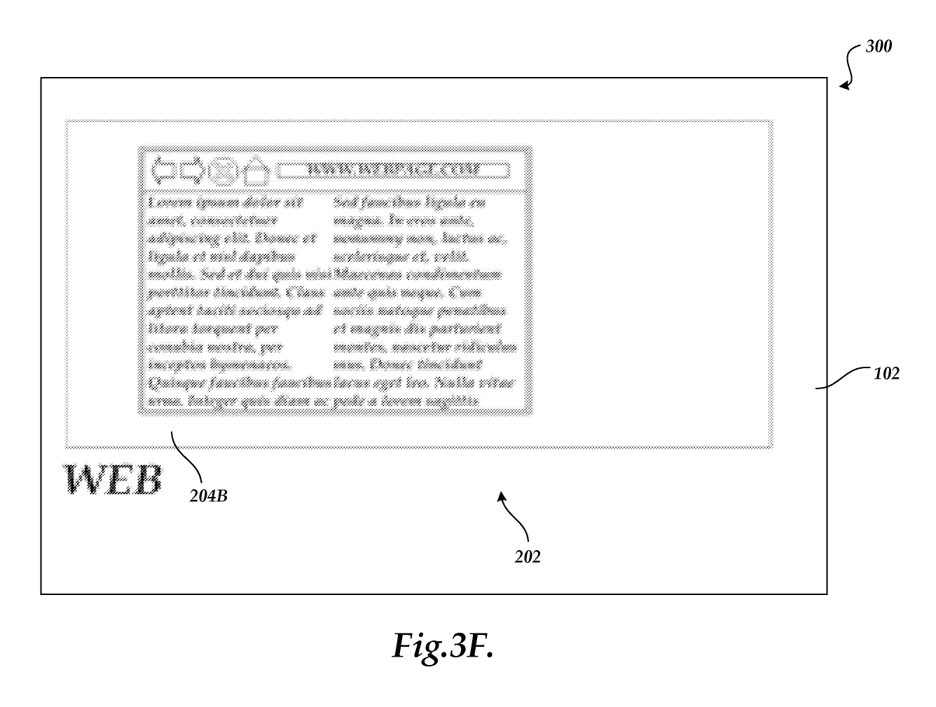

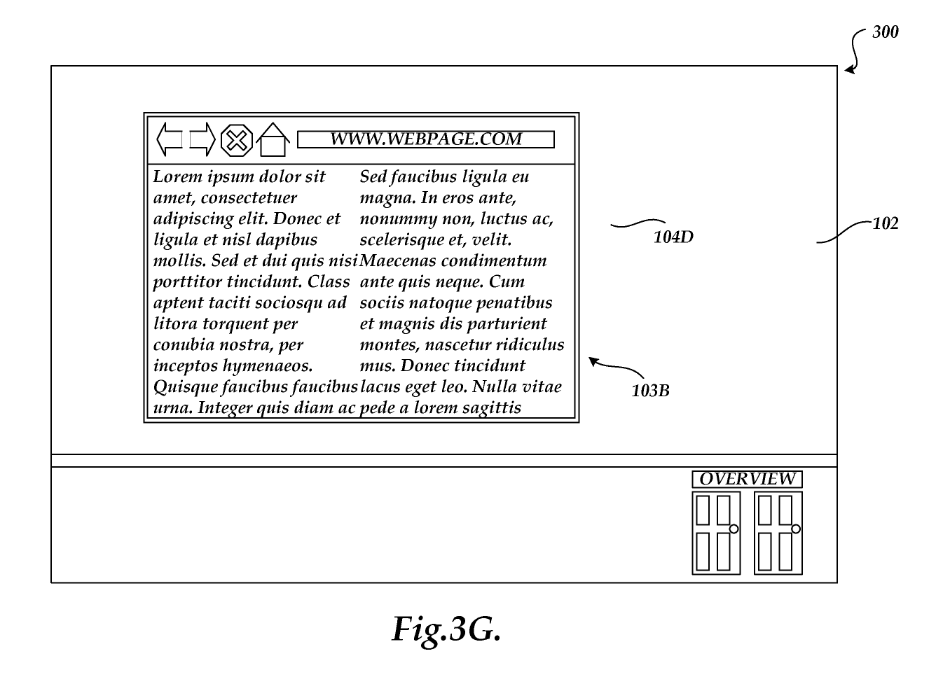

The display area 102 also includes a user interface object 108 corresponding to a task overview. As will be described in greater detail below with respect to FIGS. 2A-2J and 3A-3G, the overview provides a graphical representation of all active tasks. From the overview, one of the tasks can be brought into focus by selecting the graphical representation of the desired task. Additional details regarding this process are provided below.

In one embodiment presented herein, the user interface 100 allows a user to switch tasks through the selection of one of the user interface objects 106. In particular, selection of one of the user interface objects 106 will cause the display area 102 to bring the task associated with the selected user interface object into focus. For instance, in the example shown in FIG. 1A, a user may select the user interface object 106B to cause the task 103B to be brought into focus. In response to such a selection, the display area 102 fluidly zooms into the user interface object 106B. This process is illustrated in FIGS. 1A-1F. The display area then zooms out of the user interface object 106B to focus on the task 103B in the display area 102. This process is illustrated in FIGS. 1G-1J. As shown in FIG. 1J, the illustrative task 103B consists of a single user interface window 104D.

In order to provide the fluid zooming capabilities described herein, the embodiments presented herein utilize algorithms that allow for fluid and continuous transitions between zoom levels. This process is described in one or more of U.S. Pat. No. 7,075,535, filed Mar. 1, 2004, and entitled “System and Method for Exact Rendering in a Zooming User Interface,” U.S. patent application Ser. No. 11/208,826, filed Aug. 22, 2005, and entitled “System and Method for Upscaling Low-Resolution Images,” Provisional U.S. Patent Application No. 60/619,053, filed Oct. 15, 2004, and entitled “Nonlinear Caching for Virtual Books, Wizards or Slideshows,” Provisional U.S. Patent Application No. 60/619,118, filed on Oct. 15, 2004, and entitled “System and Method for Managing Communication and/or Storage of Image Data,” and U.S. patent application Ser. No. 11/082,556, filed Mar. 17, 2005, and entitled “Method for Encoding and Serving Geospatial Or Other Vector Data as Images,” each of which is expressly incorporated herein by reference in its entirety.

Turning now to FIGS. 2A-2J, details regarding additional aspects of the user interface presented above with respect to FIGS. 1A-1J will be described. In particular, FIGS. 2A-2J illustrate one method for displaying an overview of the currently active tasks. As shown in FIG. 2A, the user interface 200 includes a user interface object 108 corresponding to a task overview as discussed briefly above. When a user selects the user interface object 108, the display area 102 fluidly zooms into the user interface object 108. This is illustrated in FIGS. 2A-2F. The display area 102 then fluidly zooms out of the user interface object 108 to reveal the overview 202 in the display area 102. This process is illustrated in FIGS. 2G-2J.

As shown in FIG. 2J, the overview 202 includes visual representations of each of the active tasks. For instance, in the example illustrated in FIG. 2J, the overview 202 includes a task representation 204A corresponding to the task 103A and a task representation 204B corresponding to the task 103B. In this example, the task representations 204A-204B are scaled down versions of the tasks 103A-103B, respectively. However, other text, icons, or graphical indicators could be utilized for the task representations.

According to one implementation, the task representations may be selected by a user to zoom into the associated task. For instance, a user may utilize a mouse, keyboard, or other input device to select the task representation 204A illustrated in FIG. 2J. In response to such a selection, the display area 102 may fluidly zoom into the task 103A, thereby bringing the task 103A into focus. Alternatively, the user may select the task representation 204B. This will cause the display area 102 to fluidly zoom into the task 103B, thereby bringing the task 103B into focus. This is shown in FIGS. 3D-3G and described below. It should be appreciated that any number of tasks may be represented within the overview 202.

Referring now to FIGS. 3A-3G, additional details regarding other aspects of the user interface presented above with respect to FIGS. 1A-1J and 2A-2J will be described. In particular, FIGS. 3A-3G illustrate another method for displaying the overview of the current tasks. In this implementation, a selection of the user interface object 108 corresponding to the overview causes the display area 102 to fluidly zoom out of the task that is currently in focus to reveal the overview 202. This is illustrated in FIGS. 3A-3D.

As discussed above, one of the task representations 204 shown in the overview 202 may be selected by a user to zoom into the associated task. In response to such a selection, the display area 102 fluidly zooms into the representation of the task, thereby bringing the selected task into focus. For instance, if a user selected the task representation 204B in the overview 202 shown in FIG. 3D, the display area 102 would fluidly zoom into the task 103B, thereby bringing the task into focus. This process is illustrated in FIGS. 3D-3G.

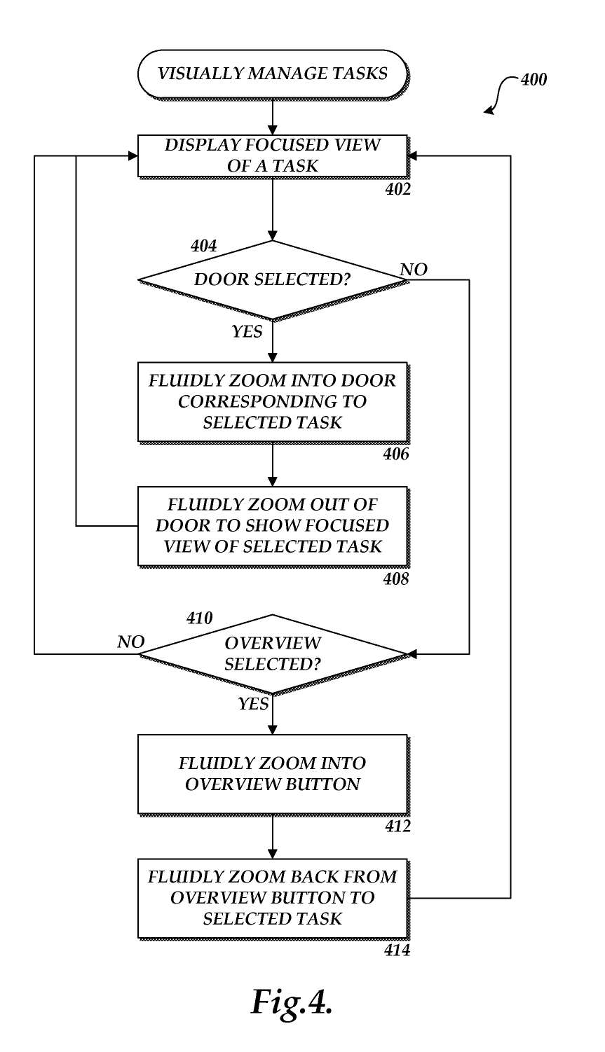

Referring now to FIG. 4, additional details will be provided regarding the user interface described above for managing tasks. In particular, FIG. 4 shows an illustrative routine 400 for providing the user interface shown in and described above with respect to FIGS. 1A-1J, 2A-2J, and 3A-3G. It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance requirements of the computing system. Accordingly, the logical operations described herein are referred to variously as operations, structural devices, acts, or modules. These operations, structural devices, acts and modules may be implemented in software, in firmware, in special purpose digital logic, and any combination.

The routine 400 begins at operation 402, where a task is displayed in focus in the display area 102. For instance, in FIG. 1A described above, the task 103A is displayed in focus. From operation 402, the routine 400 continues to operation 404, where a determination is made as to whether one of the user interface objects 106A-106B has been selected. If one of the user interface objects 106A-106B has not been selected, the routine 400 branches to operation 410, described below. If one of the user interface objects 106A-106B has been selected, the routine 400 continues to operation 406.

At operation 406, the display area 102 fluidly zooms into the selected user interface object 106. The routine 400 then continues to operation 408, where the display area 102 fluidly zooms out of the selected user interface object 106 to show a focused view of the task 103 corresponding to the selected user interface object 106. From operation 408, the routine 400 returns to operation 402, described above.

At operation 410, a determination is made as to whether the user interface object 108 corresponding to the task overview 202 has been selected. If not, the routine 400 branches back to operation 402, described above. If the user interface object 108 has been selected, the routine 400 continues to operation 412. At operation 412, the display area 102 fluidly zooms into the user interface object 108. The routine 400 then continues to operation 414, where the display area 102 fluidly zooms out of the user interface object 108 to reveal the task overview 202. As discussed above, in an alternate embodiment, selection of the user interface object 108 causes the display area 102 to zoom back from the currently displayed task 103 to reveal the task overview 202. From operation 414, the routine 400 returns to operation 402, described above.

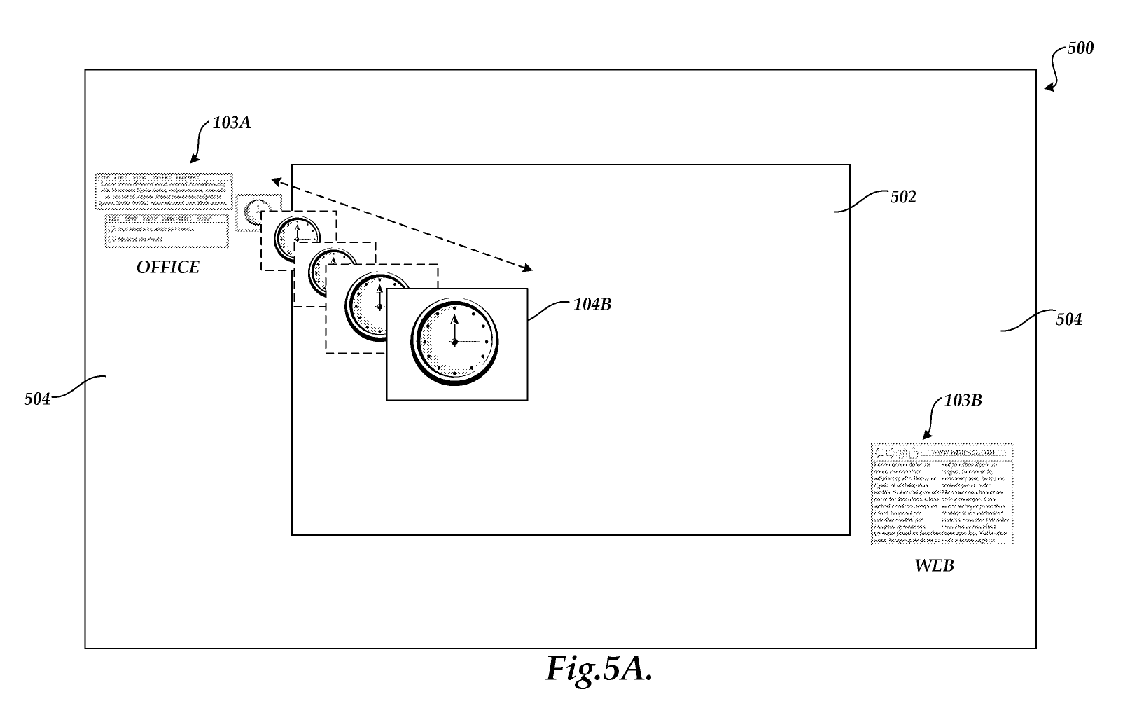

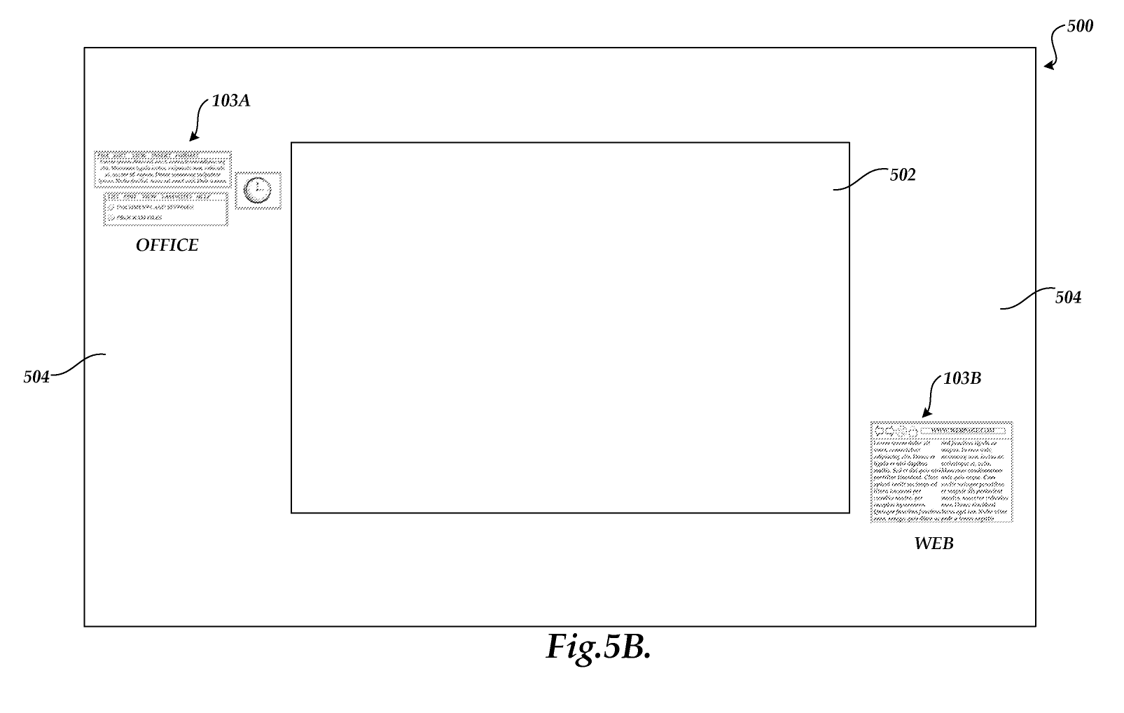

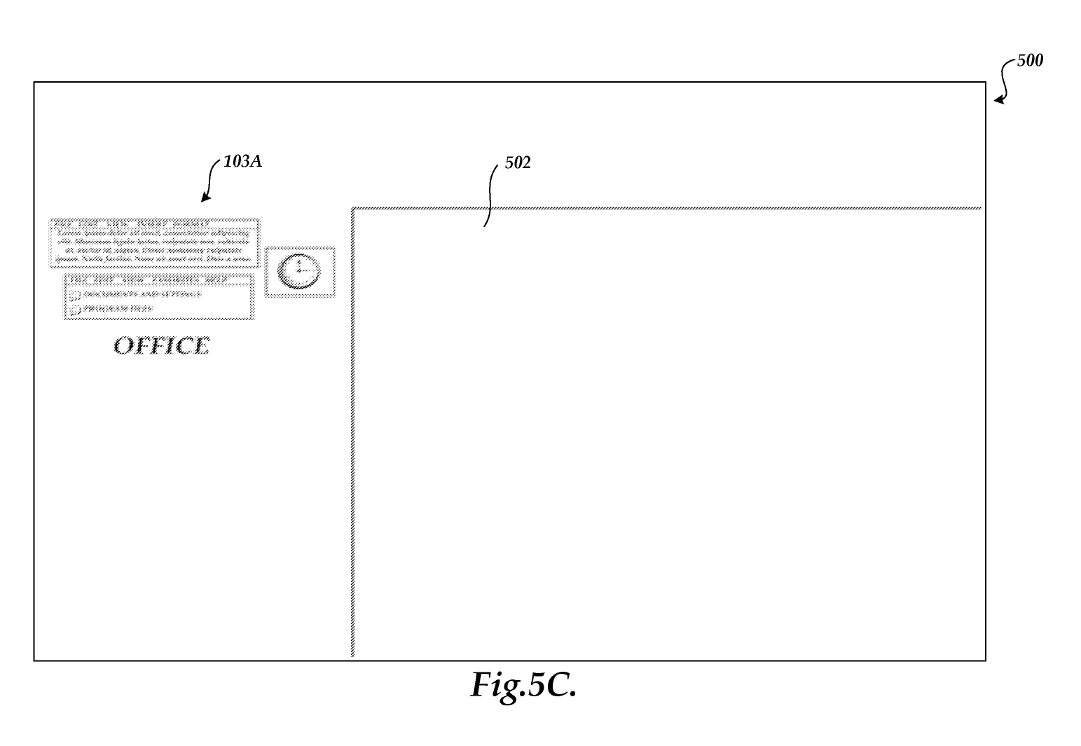

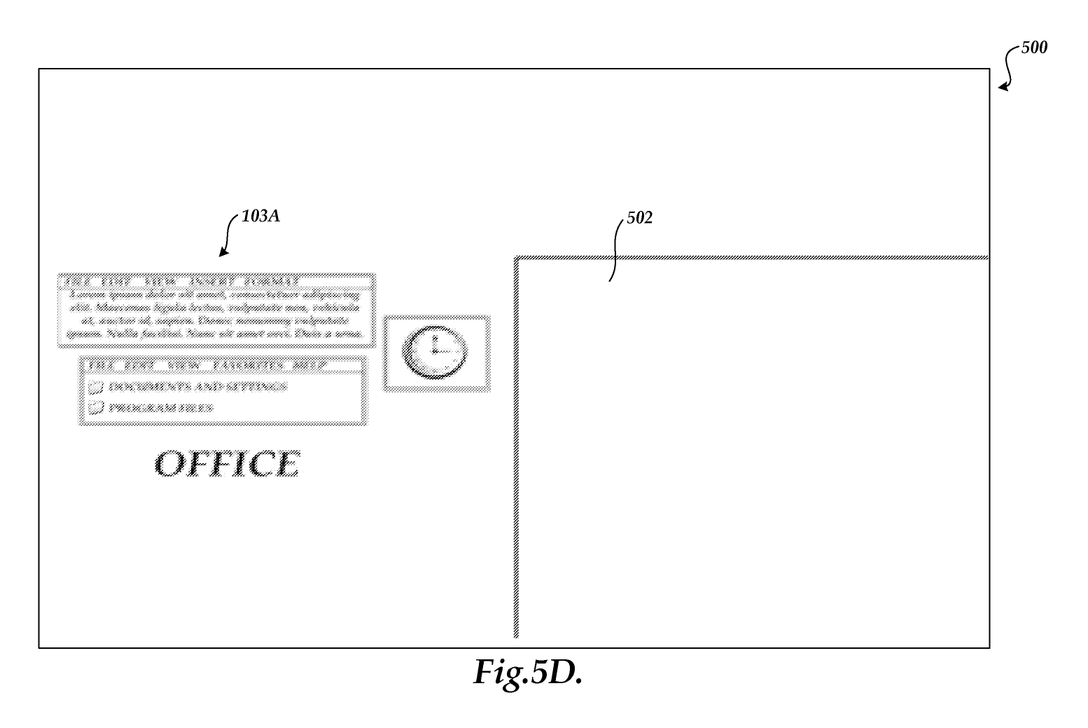

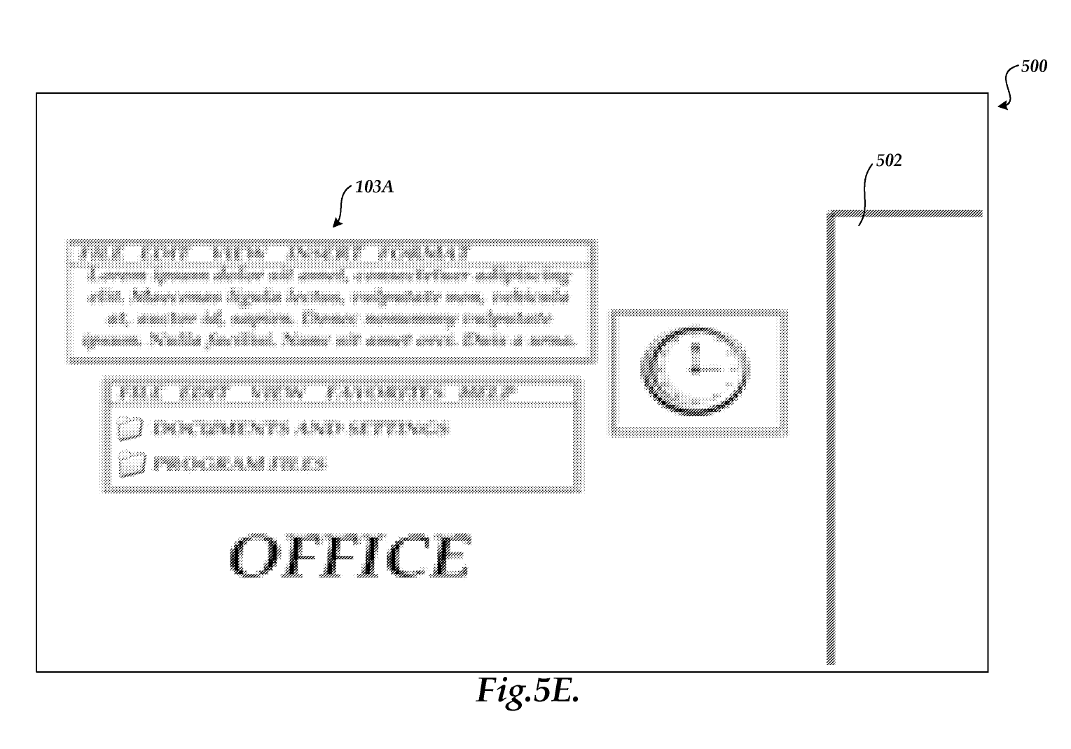

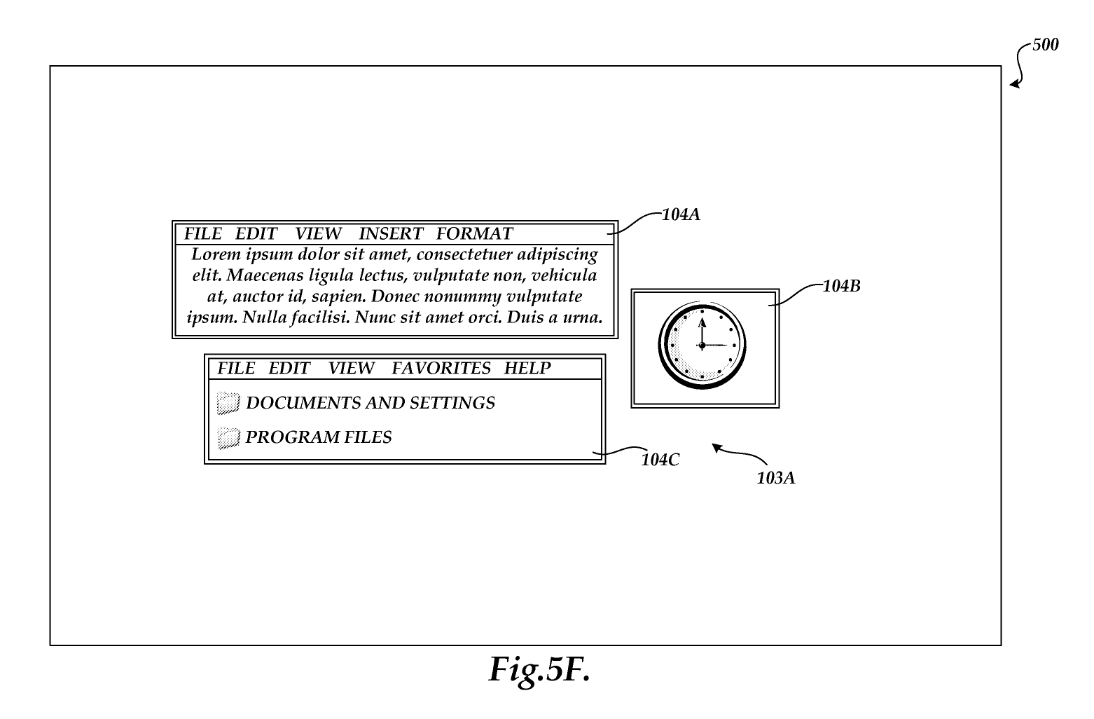

Referring now to FIGS. 5A-5F, aspects of another implementation presented herein for visually managing tasks will be described. In this implementation, a user interface is provided that includes a display area 500 having a focus area 502 and a periphery 504. The focus area 502 is utilized to display the task that is currently in focus. The periphery 504 surrounds the focus area 502 and is utilized to display information regarding tasks that are not currently in focus. For instance, in the illustrative screen display shown in FIG. 5A, visual representations of the tasks 103A and 103B are shown in the periphery 504, thereby indicating that the tasks 103A and 103B are not in focus.

In the illustrative screen display shown in FIG. 5A, the focus area 502 has a single user interface window 104B displayed therein. A user may select the user interface window 104B and move the window 104B to the periphery 504 using a mouse or other type of input device. In response to such input, the window 104B is moved to the periphery 504. Moreover, the size of the window 104B is progressively decreased as the window 104B moves from the focus area 502. When the window 104B is moved from the periphery 504 to the focus area 502, the size of the window 104B is progressively increased until the window 104B reaches its original size. Additional details regarding the process of scaling windows as they are moved to and from the periphery 504 can be found in U.S. patent application Ser. No. 10/374,351, filed on Feb. 25, 2003, and entitled “System and Method That Facilitates Computer Desktop Use Via Scaling of Displayed Objects With Shifts to the Periphery,” which is expressly incorporated herein by reference in its entirety.

According to other implementations, the tasks 103A-103B shown in the periphery 504 may be selected to bring the selected task into focus in the focus area 502. For instance, in the illustrative screen display shown in FIG. 5B, the focus area is empty. If a user selects the task 103A, the display area 500 fluidly zooms into the selected task 103A. The zooming process is illustrated in FIGS. 5B-5F. Once the selected task 103A is in focus, the user may request to return to the overview shown in FIG. 5B. In response to such a request, the display area 500 fluidly zooms out of the task in focus to return to the screen display shown in FIG. 5B.

According to other implementations, the focus area 502 and the periphery 504 may be displayed during the zooming process and while a task is in focus. In this manner, the tasks shown in the periphery 504 are always available for selection. Additionally, individual windows within a particular task may be moved to the periphery 504 to associate the windows with other tasks. When moved, the windows are scaled in the manner described above.

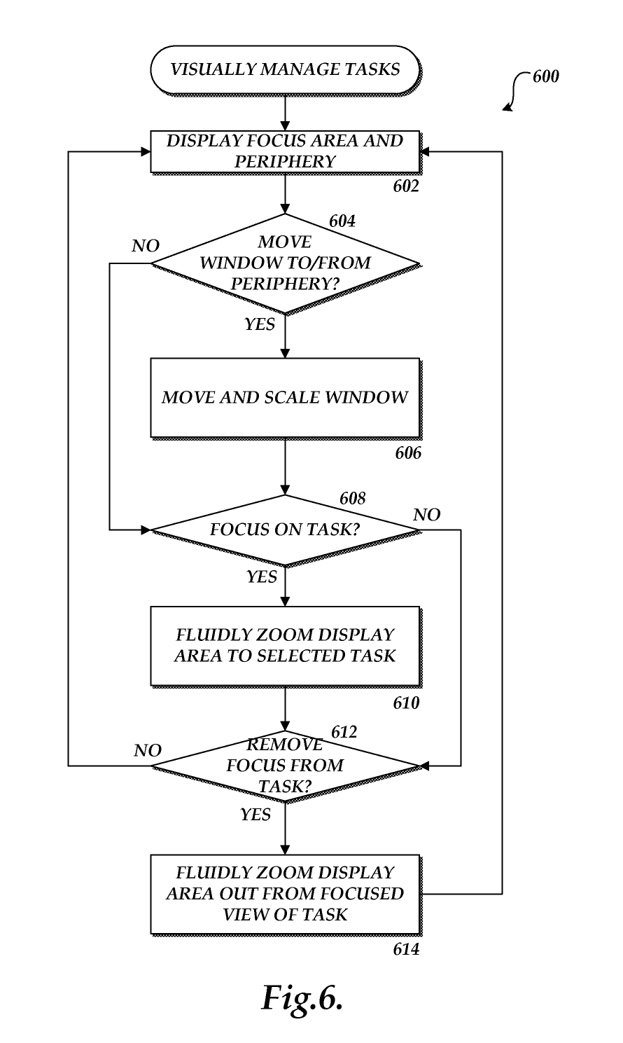

Turning now to FIG. 6, an illustrative routine 600 will be described for providing the user interface shown in and described above with respect to FIGS. 5A-5F. The routine 600 begins at operation 602, where the focus area 502 and the periphery 504 are displayed. One of the tasks is also displayed in the focus area 502. From operation 602, the routine 600 continues to operation 604, where a determination is made as to whether a window 104 is being moved to or from the periphery 504. If not, the routine 600 branches from operation 604 to operation 608, described below. If a window 104 is being moved to or from the periphery 504, the routine 600 continues to operation 606 where the window is scaled in the manner described above. From operation 606, the routine 600 continues to operation 608.

At operation 608, a determination is made as to whether a user has requested that one of the tasks 103 shown in the periphery 504 be brought into focus, such as through the selection of the desired task 103. If not, the routine 600 branches to operation 612 described below. If a request has been received to focus on a task, the routine 600 continues from operation 608 to operation 610. At operation 610, the display area 500 is fluidly zoomed into the selected task, thereby bringing the selected task into focus. From operation 610, the routine 600 continues to operation 612.

At operation 612, a determination is made as to whether a request has been received to remove focus from a task. If not, the routine 600 returns to operation 602, described above. If a request has been received to remove the focus from a task, the routine 600 continues to operation 614, where the display area 500 is fluidly zoomed out of the task in focus. The routine 600 then continues from operation 614 to operation 602, described above.

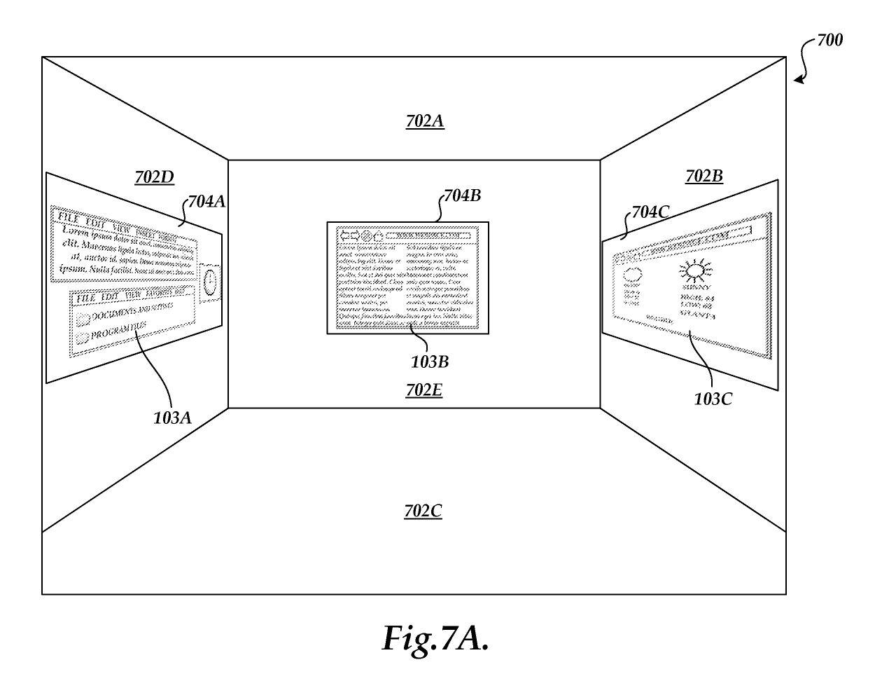

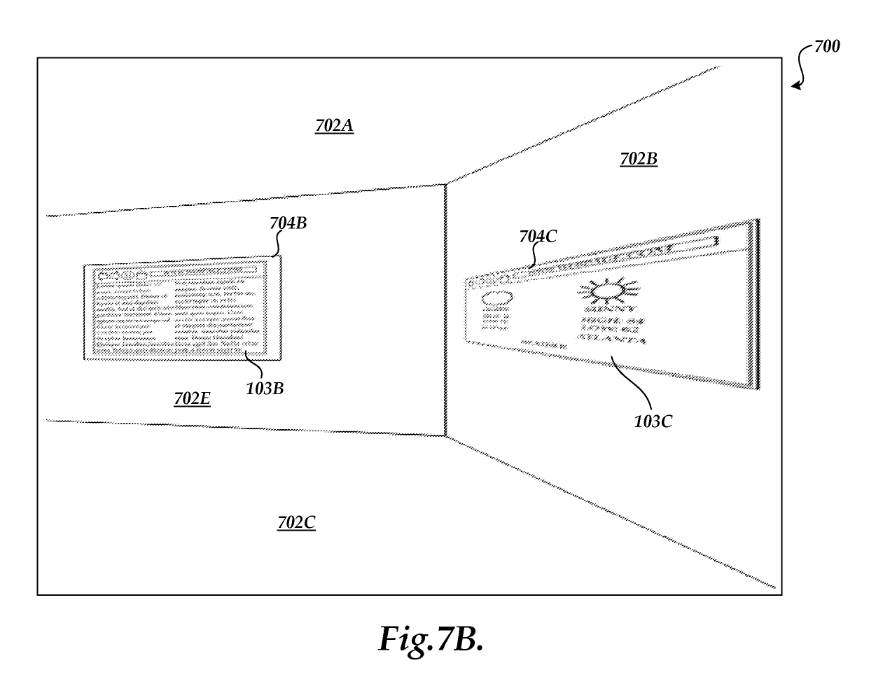

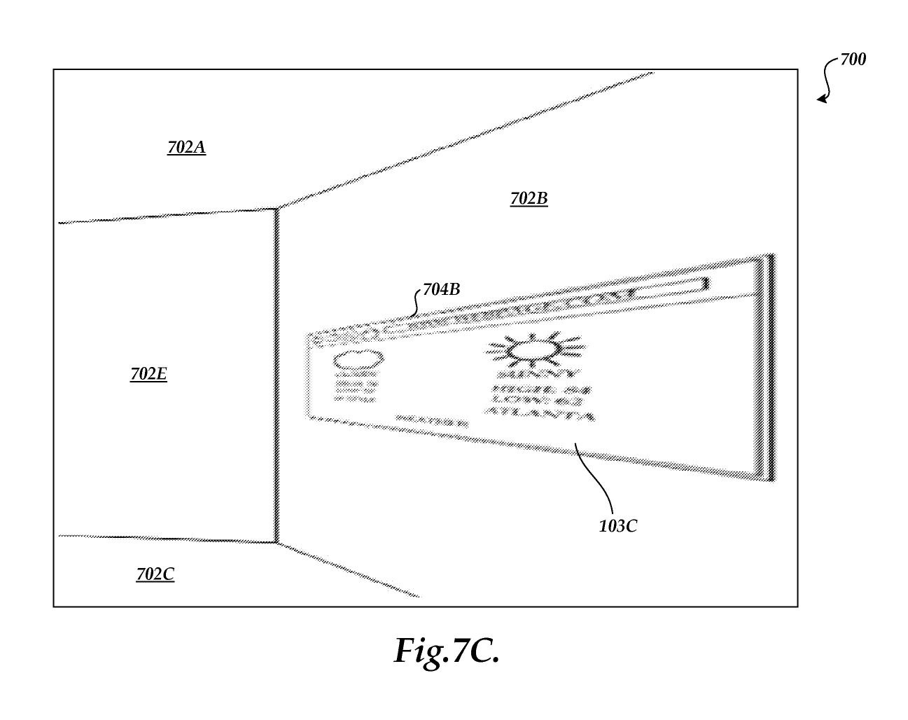

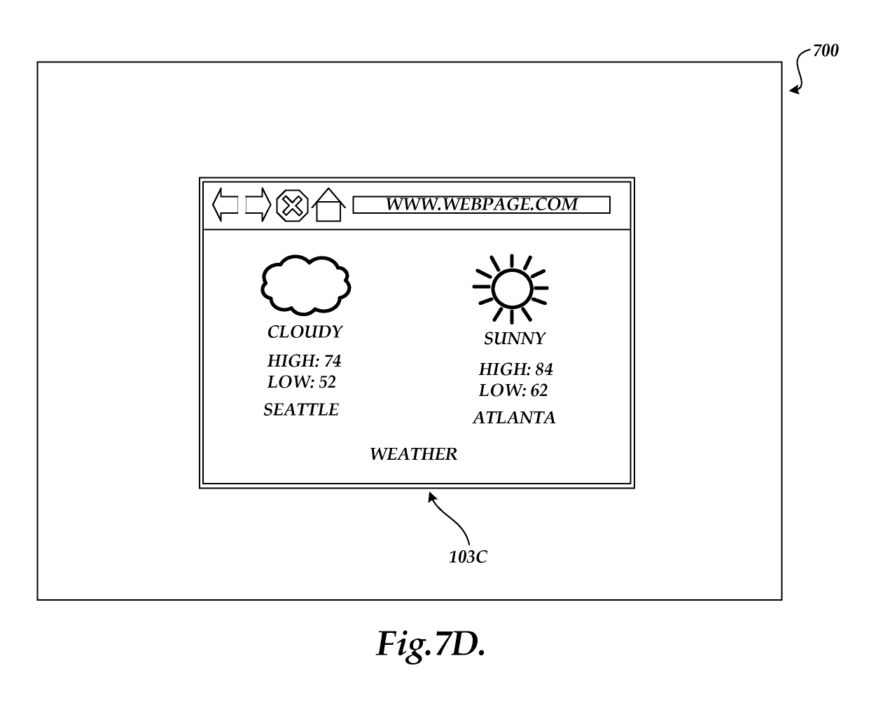

Referring now to FIGS. 7A-7D, aspects of another implementation presented herein for visually managing tasks will be described. In this implementation, a user interface is provided that includes a display area 700 that includes a three-dimensional representation of an art gallery. In this implementation, the gallery includes the walls 702B, 702D, and 702E, a floor 702C, and a ceiling 702A. The walls 702B, 702D, and 702E, include frames 704C, 704B, and 704A, respectively. A task is displayed within each of the frames. For instance, in the illustrative screen display shown in FIG. 7A, the frame 704A includes the task 103A, the frame 704B includes the task 103C, and the frame 704C includes the task 103B. In other embodiments, the frames 704A-704C may be displayed on easels. Additional details regarding aspects of a task gallery user interface such as the one illustrated in FIGS. 7A-7D can be found in U.S. Pat. No. 6,909,443, filed on Mar. 31, 2000, and entitled “Method and Apparatus for Providing a Three-Dimensional Task Gallery Computer Interface,” which is expressly incorporated herein by reference in its entirety.

According to one implementation, the tasks 103A-103C may be selected. In response to such a selection, the display area 700 fluidly zooms in on the selected task, thereby bringing the selected task into focus within the display area 700. For instance, in the illustrative screen diagrams shown in FIGS. 7B-7D, a user has selected the task 103C. In response thereto, the display area 700 fluidly zooms into the selected task 103C until the selected task occupies the entire display area 700, as shown in FIG. 7D. In order to return to the view of the gallery shown in FIG. 7A, the display area 700 may fluidly zoom out of the task in focus.

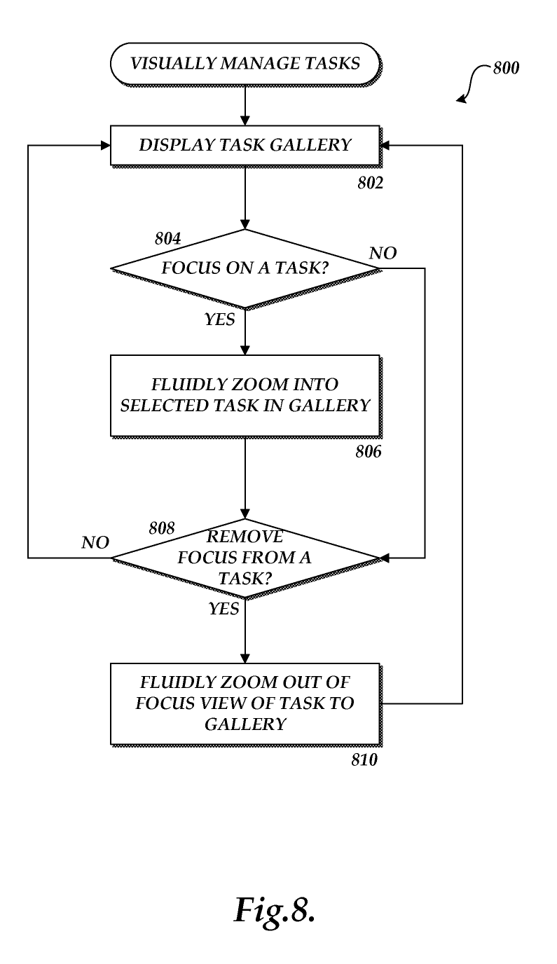

Turning now to FIG. 8, an illustrative routine 800 will be described for providing the user interface shown in and described above with respect to FIGS. 7A-7D. The routine 800 begins at operation 802, where the task gallery is displayed in the manner described above with respect to FIG. 7A. The routine 800 then continues to operation 804, where a determination is made as to whether a user has requested to focus on a task. If not, the routine 800 branches to operation 808, described below. If a user has requested to focus on a task, the routine 800 continues to operation 806, where the display area 700 fluidly zooms into the frame containing the selected task until the task occupies the entire display area 700. The routine 800 then continues from operation 806 to operation 808.

At operation 808, a determination is made as to whether a request has been received to remove focus from a task. If not, the routine 800 branches to operation 802, described above. If a request has been received to focus on a task, the routine 800 continues from operation 808 to operation 810, where the display area 700 fluidly zooms out of the focused task to reveal the task gallery. From operation 810, the routine 800 returns to operation 802, described above.

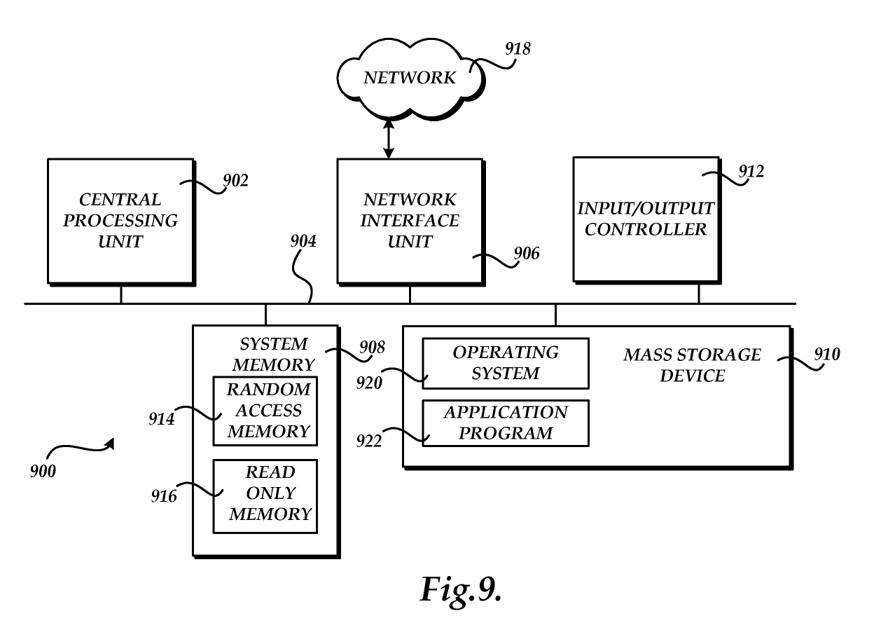

Referring now to FIG. 9, an illustrative computer architecture for a computer 900 utilized in the various embodiments presented herein will be discussed. The computer architecture shown in FIG. 9 illustrates a conventional desktop, laptop computer, or server computer. The computer architecture shown in FIG. 9 includes a central processing unit 902 (“CPU”), a system memory 908, including a random access memory 914 (“RAM”) and a read-only memory (“ROM”) 916, and a system bus 904 that couples the memory to the CPU 902. A basic input/output system containing the basic routines that help to transfer information between elements within the computer 900, such as during startup, is stored in the ROM 916. The computer 900 further includes a mass storage device 910 for storing an operating system 920, an application program 922, and other program modules, which will be described in greater detail below.

The mass storage device 910 is connected to the CPU 902 through a mass storage controller (not shown) connected to the bus 904. The mass storage device 910 and its associated computer-readable media provide non-volatile storage for the computer 900. Although the description of computer-readable media contained herein refers to a mass storage device, such as a hard disk or CD-ROM drive, it should be appreciated by those skilled in the art that computer-readable media can be any available media that can be accessed by the computer 900.

By way of example, and not limitation, computer-readable media may include volatile and non-volatile, removable and non-removable media implemented in any method or technology for storage of information such as computer-readable instructions, data structures, program modules or other data. For example, computer-readable media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer 900.

According to various embodiments, the computer 900 may operate in a networked environment using logical connections to remote computers through a network 918, such as the Internet. The computer 900 may connect to the network 918 through a network interface unit 906 connected to the bus 904. It should be appreciated that the network interface unit 906 may also be utilized to connect to other types of networks and remote computer systems. The computer 900 may also include an input/output controller 912 for receiving and processing input from a number of other devices, including a keyboard, mouse, or electronic stylus (not shown in FIG. 9). Similarly, an input/output controller may provide output to a display screen, a printer, or other type of output device (also not shown in FIG. 9).

As mentioned briefly above, a number of program modules and data files may be stored in the mass storage device 910 and RAM 914 of the computer 900, including an operating system 920 suitable for controlling the operation of a networked desktop or laptop computer, such as the WINDOWS XP operating system from MICROSOFT CORPORATION of Redmond, Wash., or the WINDOWS VISTA operating system, also from MICROSOFT CORPORATION. The mass storage device 910 and RAM 914 may also store one or more program modules. In particular, the mass storage device 910 and the RAM 914 may store an application program 922. It should be appreciated that the user interfaces described herein may be provided by the operating system 920 or by an application program 922 executing on the operating system 920. Tasks may also include windows generated by the operating system 920 or by application programs 922 executing on the computer 900. Other program modules may also be stored in the mass storage device 910 and utilized by the computer 900.

Based on the foregoing, it should be appreciated that systems, methods, and computer-readable media for visually managing tasks are provided herein. Although the subject matter presented herein has been described in language specific to computer structural features, methodological acts, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A computer-implemented method for visually managing two or more tasks, the method comprising:
displaying a three-dimensional representation of a gallery, the gallery including visual representations of one or more tasks;
receiving a request to focus on a selected task represented in the gallery; and
in response to receiving the request to focus on a task in the gallery, fluidly zooming into the visual representation of the selected task in the gallery to thereby display a focused view of the task.

2. The computer-implemented method of claim 1, further comprising:
receiving a request to remove focus from the selected task; and
in response to receiving the request to remove focus from the selected task, fluidly zooming out of the visual representation of the selected task to thereby display the gallery.

3. The computer-implemented method of claim 2, wherein the gallery comprises one or more walls, a floor, and a ceiling.

4. The computer-implemented method of claim 3, wherein the visual representations of the tasks are displayed within frames on one or more walls of the gallery.

5. A computer-readable media having computer-executable instructions stored thereupon which, when executed by a computer, cause the computer to:
display a three-dimensional representation of a gallery, the gallery including visual representations of one or more tasks;
receive a request to focus on a selected task represented in the gallery; and
in response to receiving the request to focus on a task in the gallery, to fluidly and continuously zoom into the visual representation of the selected task in the gallery to thereby display a focused view of the task.

6. The computer-readable media of claim 5, having further computer-executable instructions stored thereupon which, when executed by the computer, will cause the computer to:
receive a request to remove focus from the selected task; and
in response to receiving the request to remove focus from the selected task, to fluidly zoom out of the visual representation of the selected task to thereby display the gallery.

7. The computer-readable media of claim 6, wherein the gallery comprises one or more walls, a floor, and a ceiling.

8. The computer-readable media of claim 7, wherein the visual representations of the tasks are displayed within frames on one or more walls of the gallery.
